(19) United States
(12) Patent Application Publication
(10) Pub. No.: US 2020/0260287 A1
(43) Pub. Date: Aug. 13, 2020

(54) REAL-TIME MONITORED MOBILE DEVICE SECURITY

(71) Applicant: Guy Hendel, San Francisco, CA (US)

(72) Inventor: Guy Hendel, San Francisco, CA (US)

(21) Appl. No.: 16/860,032

(22) Filed: Apr. 27, 2020

Related U.S. Application Data
(63) Continuation of application No. PCT/US2018/057870, filed on Oct. 26, 2018.
(60) Provisional application No. 62/577,797, filed on Oct. 27, 2017.

(51) Int. Cl. H04W 12/12; G06F 21/88; H04W 12/00; G06F 21/74; G06N 20/00; G06N 5/04; H04W 4/80

(52) U.S. Cl. CPC H04W 12/1206; G06F 21/88; H04W 12/0027; H04W 12/00503; G06F 2221/2111; G06F 21/74; G06N 20/00; G06N 5/04; H04W 4/80; H04W 12/00524

(57) ABSTRACT

A system and apparatus provide mobile device and data protection by establishing a user identifier, signature, or fingerprint in response to monitoring distances or proximities between two or more of a user's devices. A device's relative location or proximity to the user and to other devices is measured and tracked in real time to provide better device security, content protection and loss prevention. A processor of the device tracks one or more conditions indicative of wireless connectivity between one or more auxiliary devices and the mobile device, monitors whether the mobile computing device is operating within the one or more conditions, and controls operation of the mobile computing device to enforce security policies, based on the monitoring.

### CROSS REFERENCE TO OTHER APPLICATIONS

This application is a continuation of International (PCT) Application No. PCT/US2018/057870 filed Oct. 26, 2018, which claims priority to U.S. Provisional Patent Application No. 62/577,797, entitled “Proximity-Based Method and System for Mobile Device Security, Content Protection, and Loss Prevention”, filed Oct. 27, 2017, which applications are incorporated herein by reference in their entireties.

### BACKGROUND

The widespread use and rapid proliferation of mobile devices coupled with the increasing dependence of users to keep sensitive personal and business data on such devices has spurred a need to protect these devices and their contents from theft and loss. Billions of dollars are lost each year in lost or stolen mobile devices. The impact of these losses is staggering. Mobile device thefts comprise about 40% of all robberies in major cities across the United States. By some counts, over 110 million devices are stolen annually, and consumers spend an estimated 30 billion dollars each year to replace lost or stolen devices. Technological advances that drive the development of new and improved mobile devices and various wearable devices that can be used with such mobile devices only mean that these numbers will continue to grow.

Often the loss of the content or data on the device to a malicious thief is of far more importance than the loss of a device that can easily be insured and replaced. The information contained in the device may be irreplaceable and may provide access to sensitive and potentially damaging information. Losing control over personal and confidential data may lead to severe consequences. Besides facilitating identify theft and financial fraud, lost devices may trigger cumbersome disclosure laws, breach business contracts, and other liabilities. For example, when a publicly-traded entity loses a device containing sensitive data, that entity is required to notify all of its customers. The fallout that ensues may give rise not only to a marketing and public relations nightmare for the entity but may also damage its customers in a manner that is irreversible and irrecoverable.

Current practices in mobile device security focus on wiping a device's storage of all data after an event such as a loss or theft. Data destruction may sometimes be necessary, but does nothing to reduce the risk that a device will be lost in the first place. Reports have stated that there were 3.4 billion global smartphone subscriptions in January 2016, and is expected to reach 6.3 billion in the next five years, and in the same period, that tablet ownership has topped the 1 billion. But only a small percentage of mobile device users back up data on their devices, with recent reports stating that one in three consumers has suffered digital data loss. It would be desirable therefor to provide new solutions that overcome these and other limitations of the prior art.

### SUMMARY

This summary and the following detailed description should be interpreted as complementary parts of an integrated disclosure, which parts may include redundant subject matter and/or supplemental subject matter. An omission in either section does not indicate priority or relative importance of any element described in the integrated application. Differences between the sections may include supplemental disclosures of alternative embodiments, additional details, or alternative descriptions of identical embodiments using different terminology, as should be apparent from the respective disclosures.

In an aspect of the disclosure, solutions are provided that proactively prevent device loss and theft, enforce encryption of key data and communications, and facilitate easy and secure periodic backups in tandem with easy and secure data restoration in the event of the wiping of a device's data. The solutions include a method for controlling a mobile computing device to prevent or minimize loss or theft. As used herein, an “apparatus” may be, or may include, a “device,” hence, the terms “mobile computing device” and “mobile computing apparatus” or “device” and “apparatus” for short may be used interchangeably because an apparatus will always include at least one device. In addition, the term “subject device” as used herein means a mobile communication device operating an application or method as described herein for automatic security. The method for controlling a mobile computing device may include identifying, by at least one processor of a mobile computing device, one or more nodes in communication with the mobile computing device via a wireless link during a most recent period. The method may further include accessing, by the at least one processor, one or more conditions indicative of wireless connectivity between the one or more nodes and the mobile computing device. The method may further include monitoring, by the at least one processor, whether the mobile computing device is operating within the one or more conditions. The method may include controlling, by the at least one processor, operation of the mobile computing device for security, based on the monitoring. Unless otherwise specified or implied, all operations of the methods described herein are performed by the subject device, alone or in cooperation with one or more servers and/or wireless nodes (collectively, the “system”). The subject device should be capable of autonomous operation in performance of the methods but may make use of remote computing resources for certain computational or administrative operations, and generally determines its own security status by communicating or attempting to communicate with various nodes and servers (e.g., GPS transmitters or identifiable nodes).

In an aspect of the method, the wireless link for identifying the one or more nodes may be, or may include, a short-range link selected from the group consisting of a Bluetooth link, a WiFi link, a WiGig link, an RFID link, an infrared link, or an ultrasonic link. In some embodiments, the one or more nodes may include a short-range device having an effective radiated power not greater than 100 mW. In related aspect, the wireless link for identifying the one or more nodes may be or include a cellular data system link, for example a 5G, 4G, or LTE link. In an alternative, or in addition, the node may use a LORA WAN link or any other useful wireless communication link.

In an aspect of the method, the at least one processor may perform the monitoring by a rules-based algorithm with configurable parameters. For example, the at least one processor, the configurable parameters against periodic samples indicative of the wireless connectivity, wherein the configurable parameters include at least one of: a count of consecutive one of the samples exceeding a threshold, two or more different weights for different ranges of the samples' values, and a rate of change in the periodic samples. The method may further include sampling, by the at least one processor, the periodic samples selected from the group consisting of: a received signal strength indicator (RSSI), a bandwidth, a network identity indicator, a time of flight or a ping response. The parameters may be user configurable, machine configurable, or both.

In an alternative aspect of the method, the at least one processor may perform the monitoring by a machine-learning algorithm trained over a set of training data. For example, the method may include generating data for the set of training data at least in part by collecting a history of connections by the mobile communication device with the one or more nodes.

The one or more nodes may be, or may include, one or more peers to the mobile computing device each running a complementary one or more conditions indicative of wireless connectivity. The method may include responding to a query from the one or more peers. In addition, the one or more nodes may include one or more non-peers of the mobile computing device, such as a simple client.

In an aspect of the method, the controlling may include selecting and activating a security policy based on which of the one or more conditions the mobile computing device is violating. In a complementary aspect, the method may include, by the at least one processor, terminating the security policy and restoring normal operation of the mobile computing device based on the monitoring, when the monitoring shows that the mobile computing device is operating within the one or more conditions. The security policy may include one or more of: causing the mobile computing device to emit an alarm signal, locking the mobile computing device, sending a lost or stolen alert to a remote monitoring server, and deleting designated data stored on the mobile computing device. Alarms may be of various levels, for example, “lost,” “stolen,” “lost but safe,” “stolen,” or “forgotten at home.” The method may further include, by the at least one processor selecting the security policy from a plurality of different security policies based on a current condition of the mobile computing device matching one of different subsets of the one or more conditions, wherein each of the different subsets triggers selecting a different one of the plurality of different security policies. In addition, the method may include determining by the at least one processor a geographic location of the mobile computing device and adjusting the one or more conditions based on the geographic location.

The method may further include, by the at least one processor, adjusting the one or more conditions based on changes in one or more identities of the one or more nodes. In a related aspect, the method may include, by the at least one processor, maintaining in a computer memory a list of one or more qualified ones of the one or more nodes each proximally associated with at least one of a geographic location, an identified user of the mobile computing device, or another of the one or more nodes. The method may further include determining, by the at least one processor, use case criteria comprising at least one of a geographic location of the mobile computing device, the identified user, and the another of the one or more nodes, and adjusting the one or more conditions based on the use case criteria.

An apparatus for performing a method as summarized above may include a processor coupled to a memory, a wireless transceiver and a graphical user interface, wherein the memory holds program instructions in a non-transitory computer-readable medium. The program instructions when executed by the processor cause the apparatus to perform the method. Suitable apparatus may include, for example, a smartphone, tablet computer, laptop computer, smartwatch, or any other mobile computing apparatus or device. As used herein, “mobile” includes portable computers such as personal computers and laptop computers, and any computer having a smaller form factor than these.

To the accomplishment of the foregoing and related ends, one or more examples comprise the features hereinafter fully described and particularly pointed out in the claims. The following description and the annexed drawings set forth in detail certain illustrative aspects and are indicative of but a few of the various ways in which the principles of the examples may be employed. Other advantages and novel features will become apparent from the following detailed description when considered in conjunction with the drawings and the disclosed examples, which encompass all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify like elements throughout the specification and drawings.

FIGS. 1A-1E are flowcharts showing introductory aspects of a method for security of a mobile or portable computing apparatus.

FIG. 1F is a block diagram showing an example of a subject device and functional components configured for performing methods as described herein.

FIG. 2A is a block diagram showing an example of a subject device with functional and hardware components configured for performing methods as described herein.

FIG. 2B is a system diagram showing examples of peer and non-peer devices with selected hardware components in a system for performing methods as described herein.

FIGS. 3A-3B are block diagrams showing nodes in communication with a subject device (e.g., a mobile computing device) in various environments.

FIGS. 4A-4H illustrate examples of a graphical user interface showing operational features of a security application for implementing methods as described herein.

FIGS. 5A-5C illustrate an example monitoring scenario within a “safe” status envelope.

FIGS. 6A-6D illustrate an example monitoring scenario with an excursion from a “safe” status envelope to a “lost” status.

FIGS. 7A-7F illustrate an example monitoring scenario with an excursion from a “safe” status envelope to a “stolen” status and recovery of safe status.

FIGS. 8A-8H illustrate an example monitoring scenario with an excursion from a “safe” status envelope to a “stolen” status with implementation of a security policy.

FIGS. 9A-9D illustrate a second example monitoring scenario within a “safe” status envelope.

FIG. 10 illustrates a graphical display from a management reporting tool used in an exemplary embodiment.

FIG. 11 shows an example of a display showing a plot or graph of the monitored communications between two devices.

FIG. 12 shows an example of a user interface for setting various parameters that determine how the communications are obtained and monitored.

FIG. 13A shows an example of a display showing a plot or graph of the monitored communications between two devices, including an event that triggers a fast alarm.

FIG. 13B shows an example of a display showing a plot or graph of the monitored communications between two devices, including an event that triggers a slow alarm.

FIGS. 14A-D are charts showing examples of relationships between various measurement parameters and distance between wireless devices.

FIG. 15 is a flowchart showing an example of a method for controlling a mobile computing device to prevent or minimize loss or theft.

FIGS. 16-19 are flowcharts showing examples of additional and optional operations for use with the method of FIG. 15.

FIG. 20 is a block diagram showing an example of an apparatus for performing the methods of FIGS. 15-19.

### DETAILED DESCRIPTION

In some embodiments, the technique disclosed herein uses as a base for identification, tracking and monitoring mobile computing devices (e.g., Android devices, iOS devices, etc.), and other wireless devices, mobile devices, or network communication or computing nodes such as wearable devices that are capable of communicating with each other. As used herein, a “node” (sometimes also referred to herein as an “identifiable element” or “element” for short) means an electronic device capable of being uniquely identified via an exchange of digital data (e.g., using a cryptographic identifier and/or device fingerprint) in communication with another apparatus—the subject device—that performs security protocols. Nodes may be lightweight standalone devices with minimal functionality beyond responding to a security protocol or may be implemented as a component of a more sophisticated computing device, for example a smart phone, smart watch or notepad computer. Advantageously, a node may be implemented as a wearable article, for example, a brooch, pendant, ring, or key fob, with a wireless communication ability. In some embodiments, a node may be, or may include, a Radio Frequency IDentification (RFID) tag. In some embodiments, a subject device may act as a node for a different subject device. The disclosed technique operating in the subject device (that is, on the mobile computing apparatus running an application as disclosed herein) identifies a user or owner of a subject device and establishes a unique user identifier, signature, or device fingerprint using the subject device's collection of connected nodes by monitoring communications between nodes, including communications that enable the subject device to measure distances or proximities between two or more of these nodes and itself over time. The subject device tracks its own relative location, proximity or distance to the user and to the connected nodes to provide better security, content protection and loss prevention for the subject device. The subject device may execute operations to prevent loss or theft of the device and its data in the first place, 2) protect the integrity of the data at all times, 3) allow for secure data storage and easy data restoration in the event of replacing a lost or stolen device, and 4) encourage the user to change their behavior by enforcing by learning basic safety measures. As used herein, a “user device” means a mobile computing apparatus or device that is registered to an identified, authorized user or group of users; in context it may often refer to the subject device.

In some cases, the disclosed technique is used to protect a user device through several integrated processes that include, for example: establishing one or more characteristic locations for the subject device such as a home, office, car, transit/travel or other state based on communication with the user's selected connected nodes, some mobile and some stationary, which may include identifying each node's unique identification number, signature or profile; designating which, if any characteristic locations are a safe zone; defining an appropriate proximity or distance threshold between a user and a connected node or a security radius or threshold that are associated with a characteristic location or a safe zone; defining and enabling user-defined action or security policies; establishing an ongoing communication web between selected or registered nodes; constantly measuring the proximity or distance between the subject device and selected or registered nodes; establishing a motion and/or communication behavior of the subject node in relation to its characteristic connected nodes; determining a security status of the subject device in response to any user or subject device movement that may indicate a possible loss or theft of a subject device; implementing user- or system-defined policies at least partly based on each characteristic location, for example whether the characteristic location is a safe zone, and the security status of the device (e.g. safe, lost, safe but lost, stolen, on airplane, or silenced); and implementing security measures as set forth by the activated policy.

In some embodiments, the disclosed methods may include communications initiated by the subject device with one or more of its connected nodes to determine a proximity or distance between each node and the subject device. In some embodiments, the subject device may measure a wireless communication performance parameter, for example received signal strength indicator (RSSI), which may be proportional to (or in other predictable relation to) distance between the subject device and a connected node. The subject device may measure and monitor these distances in real time (e.g., without any added lag time) or at frequent intervals (e.g., once per second, once per 500 milliseconds, or more frequently). In some embodiments, the sampling interval between samples of the communications may be 50 milliseconds, but can be lower or higher depending on the application. In some embodiments, the methods may include the subject device determining its own movement behavior relative to its connected nodes based at least in part on these distance measurements. Wireless communications may be by radio waves, infrared, sound, ultrasound, Bluetooth, Wi-Fi or other current and new technologies. In some embodiments, the subject device may measure distance by timing electromagnetic time of flight inside an isolated VPN tunnel or other connection.

The method may include the subject device determining a preview-to-alarm condition or an alarm-condition based at least in part on its own sensed behavior. In some examples, the subject node may use its behavior certified by the user as routine as a baseline behavior and may sense an alarm condition at least in part by detecting a change in its own baseline behavior, for example, when a measure of the behavior exceeds a thresholds or set of thresholds called an “envelope.” The subject device may obtain the baseline behavior at least in part by monitoring communications for a set of representative samples (e.g., a set of most recent samples or a set of samples taken over a given period) and determining an expected behavior for the set of representative samples. The subject device may measure baseline behavior by calculating an average or other useful aggregate measure of the set of representative samples of the communications. The method may include the subject device displaying or otherwise outputting an indicator that indicates the preview-to-alarm condition or the alarm condition.

The method may include the subject device implementing the security measures, for example, locking the device, wiping or deleting content or device data, sending an alert or activating an alert or alarm through one or more of the devices to a possible loss or theft of the device, restricting access to the device or to an application, document, program or website on or through that device, and turning on or off access to a safe or unknown/suspect network. Additionally, in some instances, a connected server may monitor an alert sent by a subject device and deactivates the alarm on the subject device in response to determining the device has moved closer to the user to a point within a predetermined threshold, determining that the subject device has moved closer to a safe zone to a point within a predetermined threshold, and entering a password on the node.

In some embodiments, the subject device may identify unsafe environments (zones). For example, a subject device may designate an environment as unsafe when a threshold number of user devices encountered the devices in the environment and the user devices were identified as stolen. For example, Jessica is a thief who takes user devices to her home where he has a robot vacuum with a device name of “Jessica the criminal's vacuum” and a home assistant device with a device name of “Jessica the criminal's assistant device.” After a threshold number of stolen user devices identify the devices found in Jessica's home environment, the devices transmit the information about Jessica's home environment to a database where Jessica's home environment are designated as an unsafe zone. Once Jessica's home environment is identified as an unsafe zone, the user devices that enter said environment initiate safeguards responsive to the identification. In some cases, it's equally important to know when the node or user device is neither lost nor stolen but, instead, is safe. In some instances, the subject device status is determined to be safe in response to determining that the user has moved away from the node or user device beyond a predetermined forgotten threshold but that the node or user device has remained in a defined safe zone. In other instances, the user device status is determined to be safe in response to determining that the user has moved away from the node or user device beyond a predetermined forgotten threshold but that the node or user device remains in contact with other registered nodes through wireless communications.

In some instances, the subject device status is determined to be forgotten in response to determining that the user has moved away from the node beyond a predetermined forgotten threshold. In other instances, the user device status is determined to be forgotten in response to determining that the user has moved away from the user device beyond a predetermined forgotten threshold. This includes for example, leaving a user device at home, at the office or in a car. In each of these examples, as fixed-location nodes are registered through the application, and are the one or more nodes are used to define a location or safe zone, as long as the devices remain in communication with the node or the geolocation of the identifiable device does not change, thus assuring that the device remains in the defined location or safe zone, its status is classified as lost but safe.

In some instances, some public locations, such as movie theaters, or modes of transportation, such as commercial airplanes, may require users to either turn off their devices or to switch them to a limited operational mode, such as airplane. As these changes in operation may impede a device's ability to transmit geolocation signals or maintain wireless communications with other registered devices, its status is classified in different ways such as silence or airplane.

In some embodiments, the method includes activating an alarm on the node or on the user device in response to determining that the subject device status is lost or stolen, and also includes activating an alarm on the node or on the user device in response to determining that the user device status is lost or stolen.

In some cases, the method also includes deactivating the activated alarm on the node or on the user device in response to at least one of, for example, determining that the node has moved closer to the user to a point within the predetermined lost threshold, determining that the node has moved closer to the safe zone to a point within the predetermined safe zone threshold, and entering a password on the user device. Similarly, the method includes deactivating the activated alarm on the node or on the user device in response to at least one of, for example, determining that the user device has moved closer to the user to a point within the predetermined lost threshold, determining that the user device has moved closer to the safe zone to a point within the predetermined safe zone threshold, and entering a password on the user device.

In some embodiments, the method includes locking the user device in response to determining that the user device has been lost or stolen and also includes sending an alert to a cloud management monitoring system in response to determining that the user device has been lost or stolen. In some cases, the cloud management monitoring system records the user device status in response to the received alert. Moreover, a self-destruct mechanism is activated on the user device upon determining that the selected smart device has been lost or stolen. In at least one embodiment, the self-destruct mechanism includes copying device data (i.e., pictures, notes, music, etc.) to a location (i.e., a cloud server, another device, remote server) prior to deleting the data from the user device. In particular, in some cases, the self-destruct mechanism is activated in response to at least one of, for example, determining that an elapsed time has exceeded a predetermined elapsed time threshold, determining that a number of failed attempts to enter a password on the user device has exceeded a predetermined password attempt threshold; and determining that the user device has been powered off. In some examples, a counter to determine the elapsed time is initiated upon determining that the user device has been lost or stolen.

In some embodiments, a method for identifying a user of a subject device by monitoring communications between two or more devices registered through an application may include selecting a user device and a node that characteristically connects to the subject device. The node and the user device may be capable of communicating directly with each other (e.g., by a peer-to-peer or server-client connection), or may communicate through a network.

In some embodiments, the method may include the subject device selecting a fixed-location characteristic node, registering the fixed-location node and the user device in a mobile application, wherein each of the fixed-location node and the user device are capable communication via a wireless link or a combination of a wireless link and a wired network. In other words, connected nodes within a safe zone may be fixed or movable.

Establishing a characteristic location in some instances includes the subject device receiving a designation the characteristic location as a residence, an office, a vehicle, or a transit state from user input. The fixed-location node may then be associated with the designated characteristic location, i.e., with the residence, the office, the vehicle, or the transit state. In an alternative, a rules-based algorithm or a machine learning algorithm on the subject device or a connected server may qualify the characteristic location by detecting a customary, periodic, or relatively frequent proximity between the location and one or more connected nodes at the location, or by using triangulation (e.g., GPS signals). In an aspect, the subject device may assess its connected state with characteristic nodes and/or location in a continuous and ongoing manner and display each node identifier and the node-to-device proximity in real time.

In some examples, the method includes the subject device scanning each node in the plurality of identifiable elements to determine each node's identity and proximity to the subject device (together, an example of a node “status”). The method further includes determining the relative movement of the node with respect to any other selected device or node associated with the user and determining a subject device status based on communications with each node in the plurality of identifiable elements. Determining a subject device status relative to a plurality of nodes (or a single node) may include calculation of a safe zone, a security radius or threshold associated with the safe zone, and the determination of relative movement of the subject device with respect to any characteristic or known node.

The disclosed methods provide a proactive and preventative approach to device and data loss. Thus, while other secure data solutions on the market today are activated only after a subject device is lost or stolen and require someone to report the device as missing or stolen, the methods disclosed herein requires no action on behalf of the device user or owner once the subject device is activated. As time is of the essence to not only recovering a device but preventing access to the data it contains, the time it takes for the device owner to discover that a subject device as stolen is critical but often too lengthy. Eliminating unnecessary delay can prevent loss of the subject device, and frees device owners from the need to activate the system, platform, or application at any point because the secure behavior-tracking application is constantly running and the security policies remain in place even through a device reboot.

The foregoing method may be implemented by a subject device including at least one processor, an operating system configured to perform executable instructions, and a computer program including instructions executable by the digital processing device. The instructions when executed by a processor of the user device cause the user device to perform the operations of the methods described herein. The instructions may be encoded in any suitable programming language.

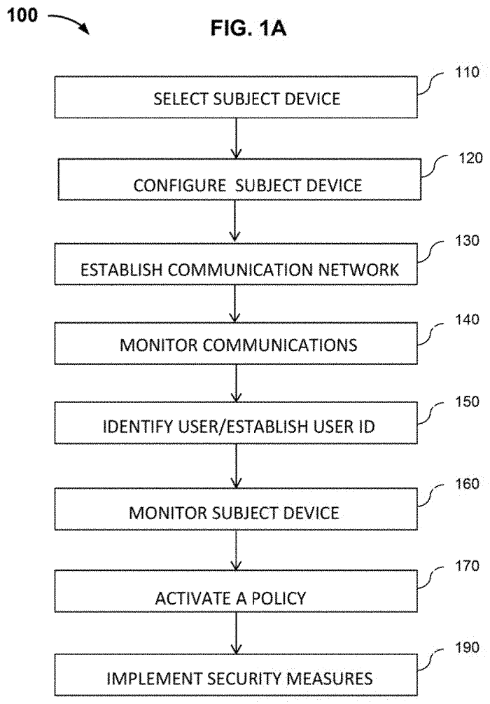

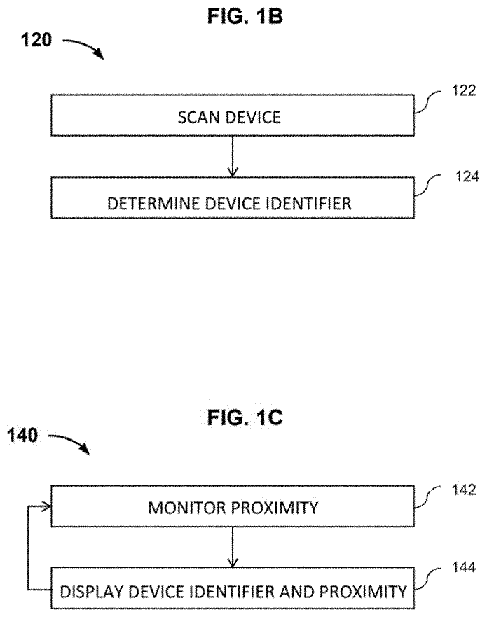

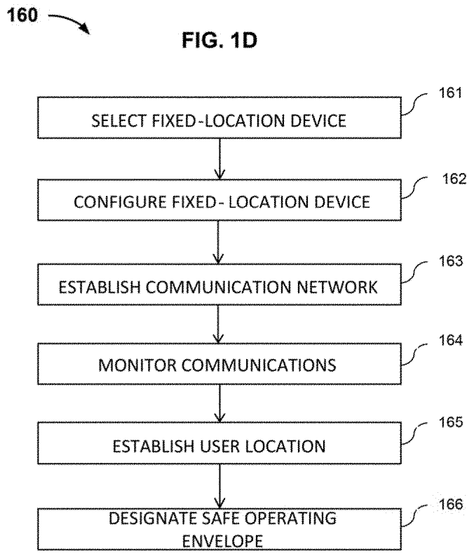

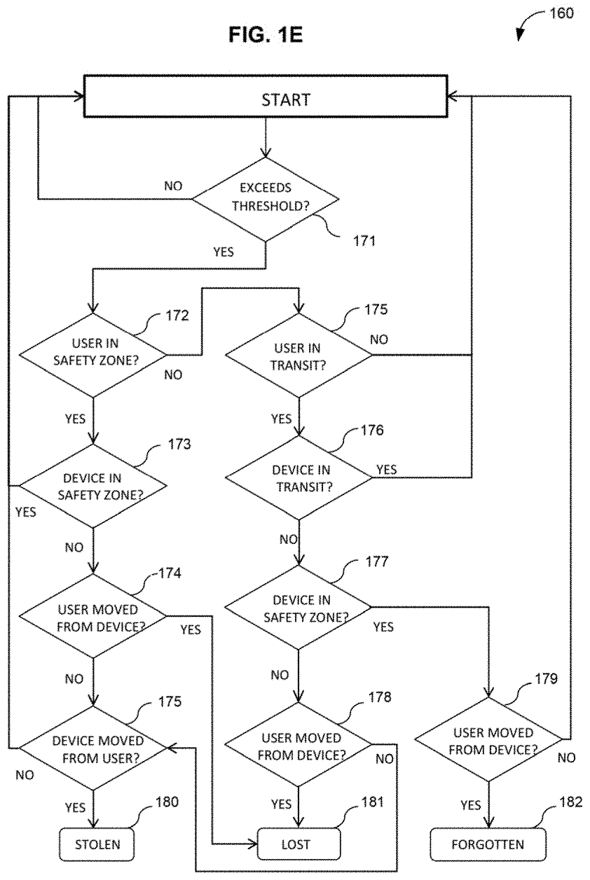

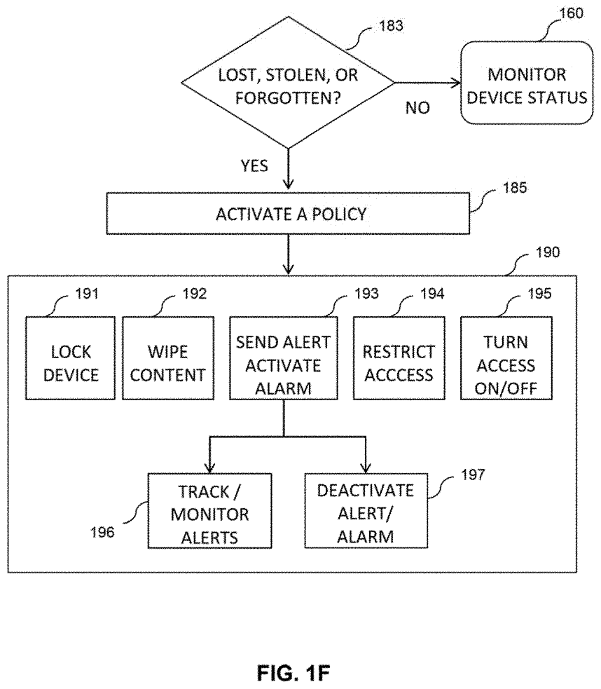

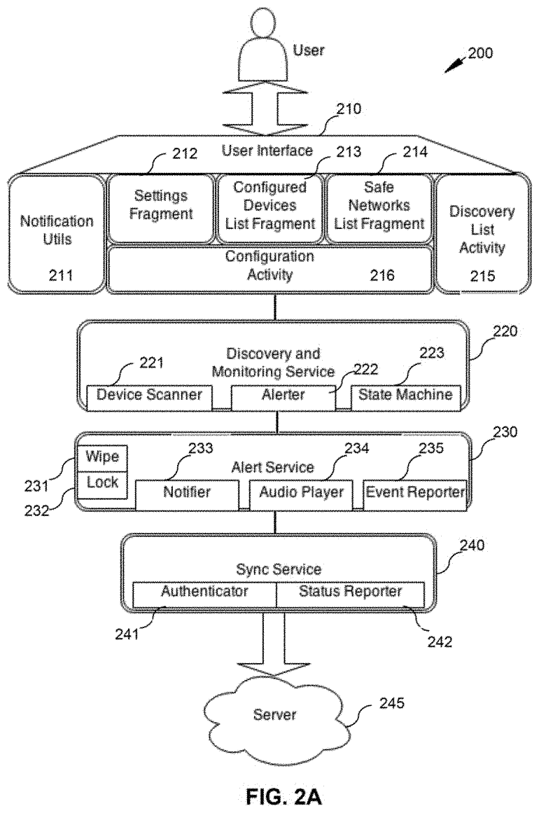

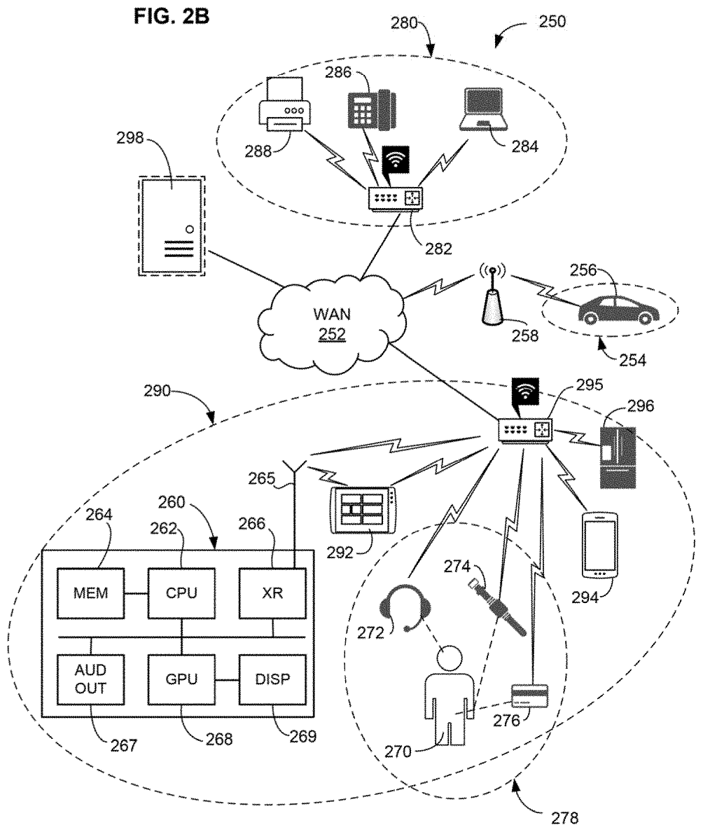

FIG. 1A is a flowchart showing a number of steps in an exemplary method 100 used to monitor proximities or distances between two or more devices, establish a unique user identifier, signature, or fingerprint, monitor the status of a user's devices, activate policies, and implement security measures to provide content protection and prevent loss of the devices. In some cases, the method 100 is performed by an exemplary system 200, which is a platform or mobile application, as illustrated in FIG. 2A.

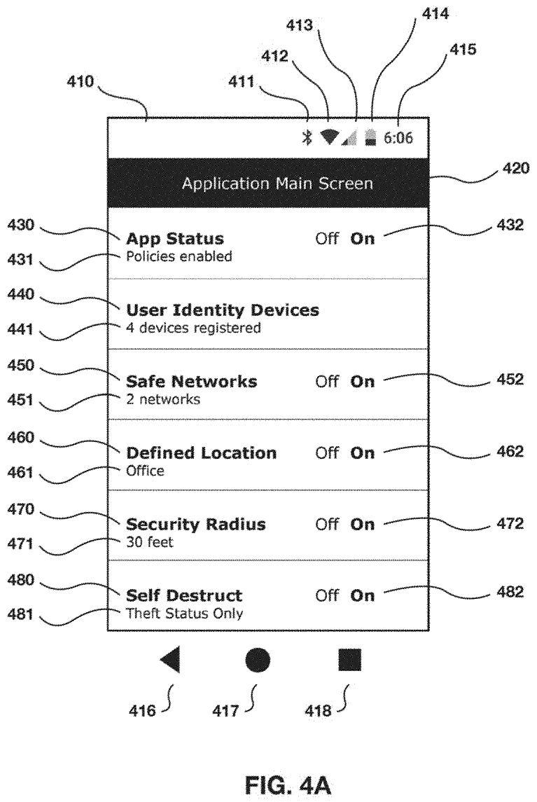

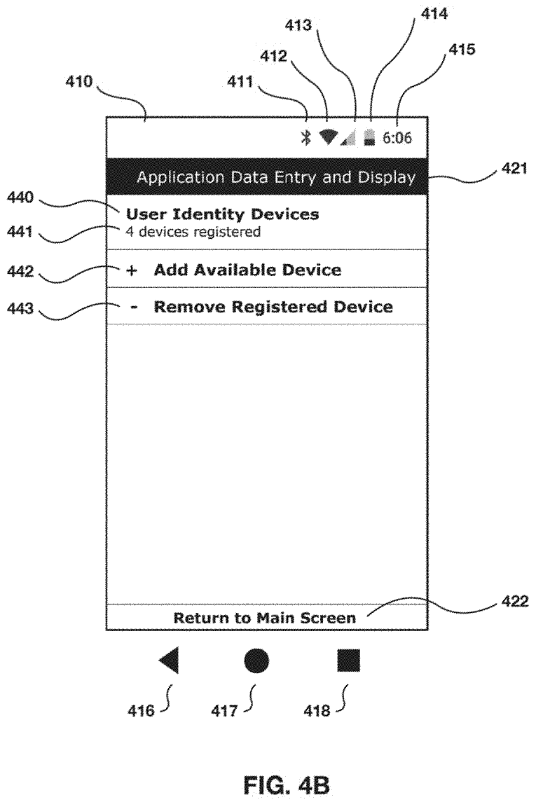

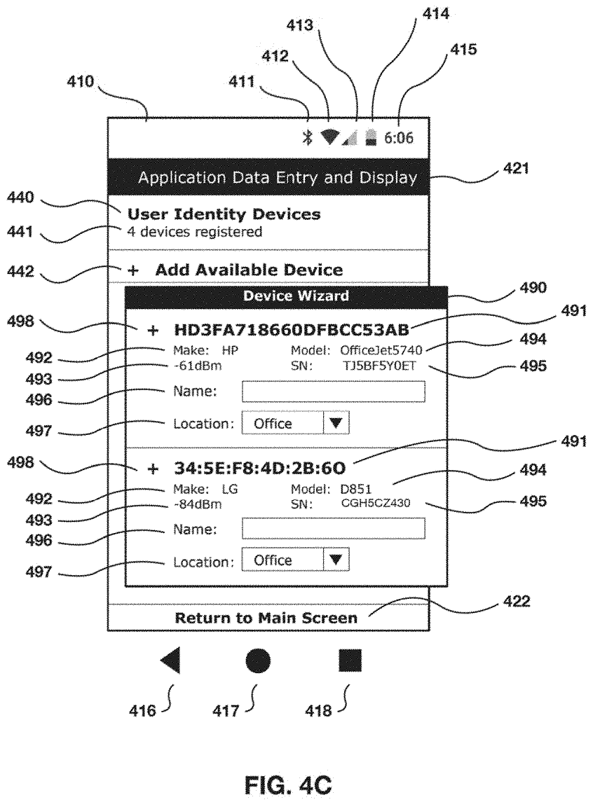

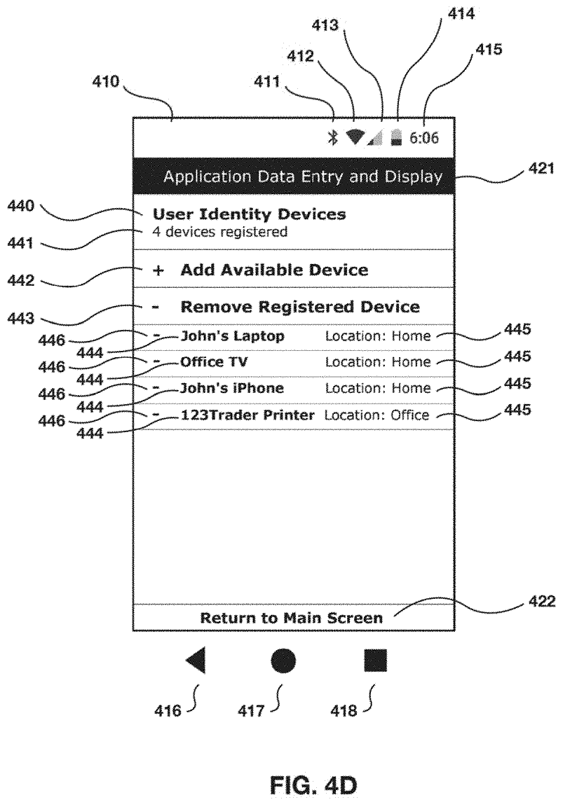

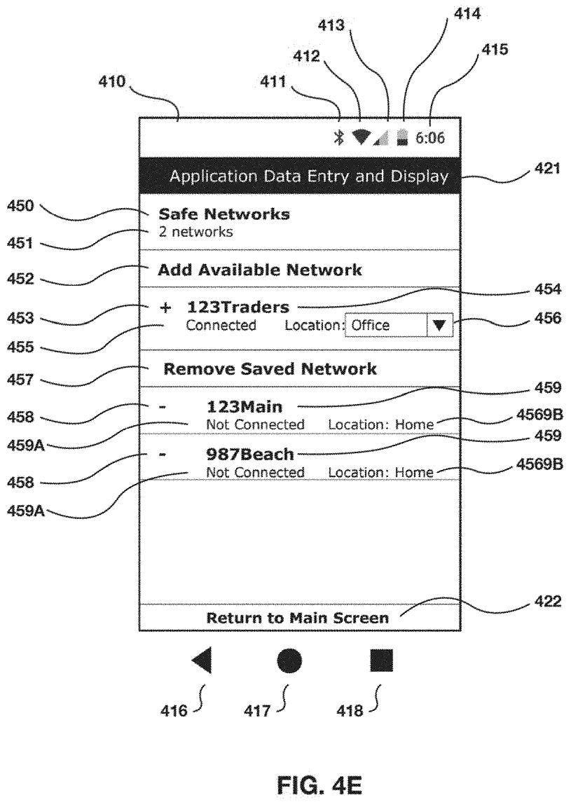

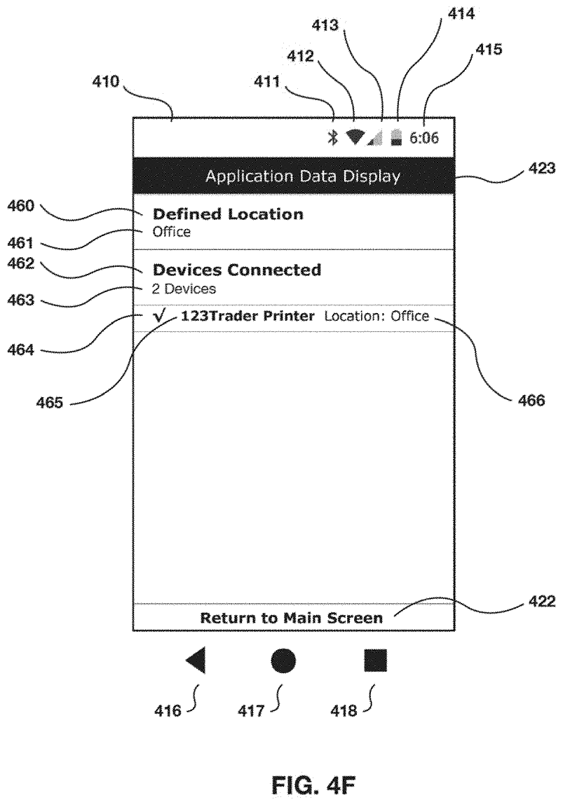

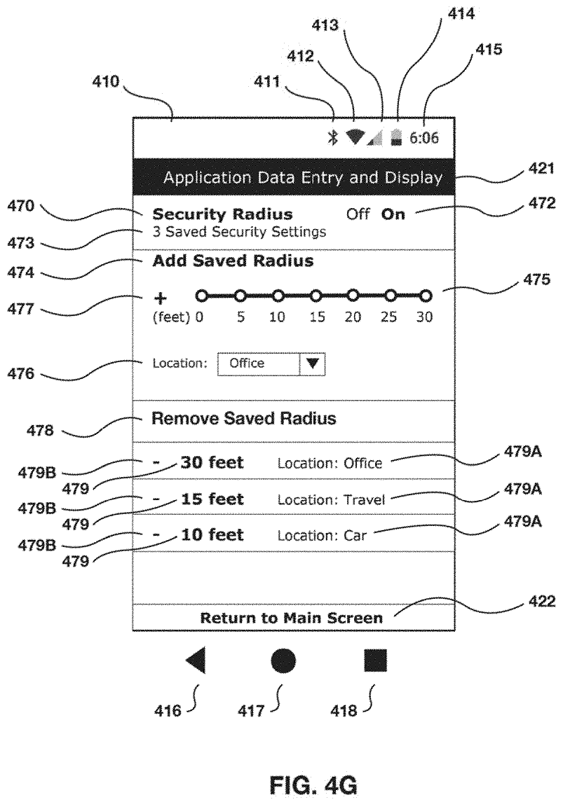

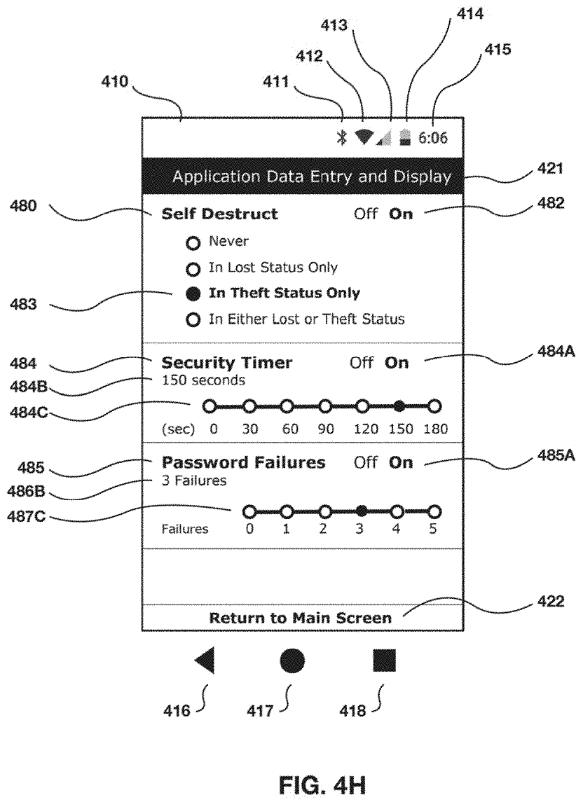

As shown in FIG. 1A, the system identifies a user device and a node associated with a user or the subject device which the user selects at 110. The node and the user device can communicate with each other. Communication may be via wireless technologies, including for example technologies such as Wi-Fi, Bluetooth, ultrasound, infrared, ZigBee, Z-wave, etc. The node and device are registered and configured in a mobile application at 120, which may include, as shown in FIG. 1B, scanning the node or the device at 122, and determining an identifier for the node such as a unique hardware or other identifier at 124. Optionally, the node is registered in a mobile application (shown for example in FIGS. 4A-4H).

For each node, specific policy and security measures are configured, registered and implemented for a selected user device or node in a mobile application at 125 (also shown in FIGS. 4A-4H). The policies and measures are fully customizable by the user to reflect personal needs and situations, corporate policy, industry requirements, and enactment of any one or more policies is based on real time conditions, data, and actions as defined by the user and recognized through the application.

The subject device may establish an ongoing communication session between the user device and the node at 130. In some embodiments, the subject device creates a web of constant communication between the node and/or among several nodes and for some constant or fixed-location nodes, such as a wireless printer at an office location or a smart television at home, and uses an assigned location to identify the user through a constant measurement of the distance the user's nodes are from each other and the physical location of these nodes. This combination of nodes/devices, relative measurements between nodes/devices and definition of location based on fixed-location nodes are used to create a unique identifier for the device user or owner.

For example, John's home environment includes an IoT refrigerator, a tablet device, and a smart lock. The subject device may store information about devices found in the home environment in a profile associated with John and/or John's mobile device (the subject device). When John's mobile device detects that it is in proximity of a threshold number (i.e., a percentage of devices, a fixed number, or all) of devices stored in association with home environment, the subject device determines that John's mobile device is in the home environment. In at least one embodiment, John runs a validation process to identify the devices in said environment (e.g., register devices) when initializing the security application on the phoe and at periodic intervals afterwards. An environment includes a work environment, home environment, a car environment, etc. Devices in the environment are identified by device characteristics, characteristics include MAC address, device name (e.g., John's refrigerator), device operating system, etc. In at least one embodiment, machine learning algorithms are used to determine information about environments associated with the user and/or to build environment profiles (i.e., work environment, home environment, etc.). Like any security system that may for example use a password to provide security, the more connected devices in use, the higher the level of uniqueness and security. In this manner, the subject device operates on a premise of protection by connection, building upon the premise wireless technologies utilize, which is to exchange data over short distances from fixed and mobile devices. The subject device take this several steps further by not only creating a communications session in which multiple devices constantly communicate with each other but also by using the physical location and ongoing measurement of distances between selected or registered nodes to create a unique identity for the device user or owner with respect to each defined location.

More specifically, as shown in FIG. 1A, the subject device monitor node-to-device communications between the identifiable node and the user device at 140. The monitoring process includes, as shown in FIG. 1C, monitoring the node-to-device communications (e.g., including node-to-device proximity or distance in response to or based at least in part on the node-to-device communications) at 142 and displaying the device identifier determined at 144 and a proximity or distance determined in response to the monitored node-to-device communications at 142. The device identifier and node-to-device communications (e.g., node-to-device proximity or distance) are displayed on a user interface 210 as illustrated in FIG. 2A. At 150, the subject device identifies the user or determines a unique user identifier, signature, or fingerprint at least in part by monitoring the node-to-device communications between the identifiable node and the user device. The subject device then proceeds to monitor the node at 160. In addition to monitoring the node, the subject device determines a status for the subject device and depending on or in response to the status determined for each node, the subject device activates a policy at 170 and implements appropriate security measures at 190.

As shown in FIG. 1D, monitoring the node at 160 may include various operations by the subject device. For example, the subject device may select a fixed-location node associated with the user at 161. In some cases, the fixed-location node has a fixed location. For example, as mentioned previously, the fixed-location node is a wireless printer located at an office location or a smart television at a home. Each of the fixed-location node and the user device are configured to be capable of communicating with each other and the fixed-location node may be configured at 162 in a similar process as previously described in connection with FIG. 1B. An ongoing communication web is established at 163, which may be a communications network that includes the fixed-location node. The subject device monitors fixed-location node communications (e.g., communications comprising a measure of proximity or distance) of the fixed-location node to the user device at 164 and establishes a characteristic location in response to communicating with the user device and the fixed-location node. The subject device may determine the characteristic location at 165 in response to monitoring the fixed-location node communications. Additionally, the characteristic location is optionally designated as a safe zone at 166 and identifying the user at 150 is in response to monitoring the fixed-location node communications and the physical location of the fixed-location node.

In other embodiments, the subject device communicates with a plurality of identifiable elements wherein monitoring the node-to-device communications between the node and the user device includes monitoring the node-to-device communications between each node in the plurality of identifiable elements and the user device. Moreover, the subject device may also communicate with a plurality of fixed-location nodes and assign each fixed-location node in its own unique fixed location identifier. Thus, in some examples, identifying the user may include monitoring a plurality of node-to-device communications and monitoring a plurality of fixed-node communications. Similarly, each of the communications from a single fixed node may be with the user device. In some cases, the node-to-device communications between the node and the user device may include a measure of proximity or distance between the node and the user device, and the fixed-location node communications between the fixed-location node and the user device comprise a measure of proximity or distance between the fixed-location node and the user device.

The method performed by the subject device in some instances further includes determining the node-to-device communications between each node in the plurality of identifiable elements and the user device, displaying a node identifier associated with each node in the plurality of identifiable elements and displaying the node-to-device communications of each node having a displayed node identifier. The node-to-device communications between a node and a subject device are determined and/or monitored in a continuous and ongoing manner and the node identifier and the node-to-device communications may be displayed and evaluated by the subject device in real time. Additionally, the node identifier and the node-to-device communications are displayed on another user device. In some cases, the node-to-device communications between the node and the user device comprise a measure of proximity or distance between the node and the user device.

In some embodiments, the subject device determines the relative movement of a node with respect to any other selected node associated with the user and determines a status for each node at 170 as illustrated in FIGS. 1A, 1D, and 1E. Determining a status for a node is in response to or based at least in part on, for example, the node-to-device communications between at least one node and a user device, the fixed-location node communications between at least one fixed-location node and a user device, a safe zone, a security radius or threshold associated with the safe zone, and the determination of relative movement of the node with respect to any other selected node associated with the user. In some cases, the node-to-device communications between the node and the user device comprise a measure of proximity or distance between the node and the user device, and the fixed-location node communications between the fixed-location node and the user device comprise a measure of proximity or distance between the fixed-location node and the user device.

This proactive approach to device and data loss prevention allows a series of possible actions based on the node location and on which node is moving away from the others. An exemplary method for determining the status of a subject device status is shown in FIG. 1E. In this example, the status of the subject device is determined as safe, lost, safe but lost, stolen, airplane, or silenced. The determination of the status is in response to the determination of the relative movement of the node with respect to any other selected node associated with the user and whether the node is within the security radius or threshold associated with the safe zone.

As shown in FIG. 1E, determining a status for a device may be triggered at 171 when the node-to-device communications (e.g., reflecting a proximity or distance of the device to the user) cross over or exceed a predetermined threshold. If the user is within a safe zone at 172 (as defined for example by a security radius or threshold associated with a characteristic location that has been designated as a safe zone) and the device is also within the safe zone at 173, the system simply continues to monitor the device. If the device is not within the safe zone and the user is determined to have moved away from the device at 174, the device status is determined as lost. If on the other hand, the user has not moved away from the device but rather, the device has moved away from the user at 175, the device status is determined as stolen at 180. If neither the user nor the device are moving away or have moved away from each other, the system continues to monitor the device until the predetermined threshold (e.g., a proximity or distance between the user and the device) is exceeded.

If the user is in transit but the device is not in transit at 175 and the device is also not in a safe zone at 177, the system checks whether the user is moving or has moved away from the device at 178. If the user is moving away from the device at 178, the device status is determined as lost. In other words, the user is in transit, is currently moving or has moved away from the device and has left the device somewhere that is not a designated safe zone. If the user is not moving away from the device at 178, the system checks whether the device is moving or has moved away from the user, and if so, determines the device status as stolen. If neither the user nor the device are moving away or have moved away from each other, the system continues to monitor the device until the predetermined threshold (e.g., a proximity or distance between the user and the device) is exceeded

The subject device status is determined as safe, lost, safe but lost, stolen, airplane, or silenced by the exemplary method at 170. As shown in FIGS. 1A and 1F, once the subject device has determined the device status, the subject device activates a policy at 185 in response to the determination of the subject device status as safe, lost, safe but lost, stolen, airplane, or silenced at 183 and implements security measures at 190 per the activated policy. As shown in FIG. 1F, examples of different security measures include: locking a node at 191, wiping or deleting content or device data at 192, sending an alert or activating an audible alert or alarm at 193 through one or more of the nodes to a possible loss or theft of a subject device, restricting access to the device or to an application, document, program or website on or through that device at 194, and turning on or off access to a safe or unknown/suspect network at 195. Additionally, at 196 the subject device tracks or monitors one or more nodes to determine the status of an alert. The subject device also deactivates the alarm at 197 in response to determining that the subject device has moved closer to the user to a point within a predetermined threshold, determining that the subject device has moved closer to a safe zone to a point within a predetermined threshold, and/or entering a password on the subject device.

The subject device includes the creation of an application-defined password that is especially important in cases where the device owner may not have put a device password into place. The application password is configured so as not to interfere with normal use of the device. The password is configured to come into play when an event, loss or theft, takes place and appropriate policies are enacted.

In another aspect, a platform including a processor of a mobile computing device configured to execute instructions from one or more software modules to provide a device monitoring and security application is disclosed. The one or more software modules include, for example, a user interface 210 software module, a discovery and monitoring service software module 220, and an alert service software module 230, as shown in FIG. 2A. In particular, the discovery and monitoring service software module includes a device scanner software module 221, a state machine software module 223, and an alerter software module 222. In some cases, the device scanner software module 221 includes instructions for identifying a node and authenticating a user device, wherein the node and the user device may be capable of wireless peer-to-peer communication with each other or other wireless link, establishing an ongoing communication web between the node and the user device, wherein the ongoing communication web is established via wireless communication directly between the node and the user device, monitoring node-to-device communications between the node and the user device in an ongoing and continuous manner and monitoring a device-to-location proximity or distance of the user device to a predetermined location. In some examples, the state machine software module 223 includes instructions for determining a user device status in response to at least one of the node-to-device communications and the device-to-location proximity or distance. The alerter software module 222 may include instructions for activating a policy in response to at least one of the mobile device status or the smart device status.

In some instances, the node may be one of a plurality of identifiable elements and the device scanner software module includes instructions for monitoring node-to-device communications between each node in the plurality of identifiable elements and the user device. Additionally, the state machine software module includes instructions for determining a unique user identifier, signature, or fingerprint in response to a plurality of node-to-device communications, each of the node-to-device communications corresponding to the communications between a single node and subject device in the plurality of node-to-device communications between any node in the plurality of identifiable elements and the user device, and determining the user device status in response to the unique user identifier, signature, or fingerprint.

In some embodiments, the user interface 210 software module includes a configuration activity software module 216 that includes instructions for providing a user interface on the user device and displaying, on the user interface, a node identifier associated with each node in the plurality of identifiable elements and the node-to-device communications of each node having a node identifier. Additionally, the device scanner software module includes instructions for scanning the node and determining a node identifier for the node. In some cases, the state machine software module includes instructions for defining a characteristic location associated with the user. In particular, the definition of the characteristic location includes at least one of, for example, a geolocation corresponding to a physical location, a predetermined wireless communication network, and the unique user identifier, signature, or fingerprint.

In some cases, the characteristic location includes a plurality of characteristic locations and the plurality of characteristic locations includes at least one of, for example, a residence, an office, a vehicle, and a transit state.

Additionally, in some examples, the state machine software module 223 includes instructions for determining that the subject device status is lost or stolen in response to designating a characteristic location as a safe zone, determining that the node has moved away from the user beyond a predetermined lost threshold, and determining that the node has moved away from the safe zone beyond a predetermined safe zone threshold. Similarly, the state machine software module 223 includes instructions for determining that the user device status is lost or stolen in response to designating a characteristic location as a safe zone, determining that the user device has moved away from the user beyond a predetermined lost threshold, and determining that the user device has moved away from the safe zone beyond a predetermined safe zone threshold.

In some embodiments, the state machine software module 223 includes instructions for determining that the subject device status is forgotten in response to determining that the user has moved away from the node beyond a predetermined forgotten threshold. The state machine software module 223 may also include instructions for determining that the user device status is forgotten in response to determining that the user has moved away from the user device beyond a predetermined forgotten threshold.

In some embodiments, the alerter software module 222 includes instructions for activating an alarm on the node or on the user device in response to determining that the subject device status is lost or stolen. Additionally, in some cases, the alerter software module includes instructions for activating an alarm on the node or on the user device in response to determining that the user device status is lost or stolen. The alerter software module 222 may also include instructions for deactivating the activated alarm on the node or on the user device in response to at least one of, for example, determining that the node has moved closer to the user to a point within the predetermined lost threshold, determining that the node has moved closer to the safe zone to a point within the predetermined safe zone threshold, and entering a password on the user device. Similarly, the alerter software module 222 may also include instructions for deactivating the activated alarm on the node or on the user device in response to at least one of, for example, determining that the user device has moved closer to the user to a point within the predetermined lost threshold, determining that the user device has moved closer to the safe zone to a point within the predetermined safe zone threshold, and entering a password on the user device.

In some embodiments, the platform includes a sync service software module 240 that includes an authenticator software module 241 having instructions for authenticating a password entered on the user device to deactivate the activated alarm and a status reporter software module 242 that includes instructions for reporting the user device status. In another aspect, the alert service software module 230 may include a lock software module 232 that includes instructions for locking the user device in response to determining that the user device has been lost or stolen. The alert service software module 230 may also include a notifier software module 233 and an event reporter software module 235. The notifier software module 233 may include instructions for sending an alert to an event reporter software module in response to determining that the user device has been lost or stolen, while the event reporter software module 235 may include instructions for recording and displaying the user device status in response to the received alert.

In some examples, the alert service software module 230 also includes, in some instances, a wipe software module 231 that includes instructions for activating a self-destruct mechanism on the user device when the user device status is determined to be lost or stolen. The self-destruct mechanism is activated in response to at least one of, for example, determining that an elapsed time has exceeded a predetermined elapsed time threshold, determining that a number of failed attempts to enter a password on the user device has exceeded a predetermined password attempt threshold, and determining that the user device has been powered off. In some embodiments, the module 231 may cause the device to initiate a counter to determine the elapsed time upon determining that the user device has been lost or stolen.

In a further aspect, a system for providing a device monitoring and security application including a digital processing device is disclosed that includes at least one processor, an operating system configured to perform executable instructions, a memory, and a computer program. In some cases, the digital processing device includes at least one processor and the memory includes storage for housing a user device status. In some embodiments, the computer program includes instructions executable by the digital processing device for selecting a node and a user device to be monitored, establishing an ongoing communication web between the node and the user device, wherein the ongoing communication web is established via wireless communication directly between the node and the user device, monitoring node-to-device communications between the node and the user device and determining a user device status in response to at least one of the node-to-device communications between the node and the user device and a device-to location proximity or distance of the user device to a predetermined location. In addition, the node and the user device are capable of wireless communication with each other and the computer program includes instructions for scanning the node, determining a node identifier for the node, and displaying the node identifier for the node and the node-to-device communications of the node to the user device, and other functions disclosed herein.

FIG. 2A is a block diagram showing several functional components 200 of an exemplary embodiment. A subject device as described herein includes a mobile device including a processor configured to execute instructions from one or more software modules to provide a device monitoring and security application, alone or in cooperation with one or more remote servers and with reference to communications with one or more identifiable nodes. The one or more software modules 200 may include, as shown in FIG. 2A and already described, a user interface 210 software module (components shown immediately under the user interface 210), a discovery and monitoring service software module 220, an alert service software module 230, and a server 245. The discovery and monitoring service software module 220 includes a device scanner software module 221, a state machine software module 223, and an alerter software module 222. The device scanner software module 221 includes instructions for identifying a node and a user device, wherein the node and the user device are capable of communicating with each other, monitoring node-to-device communications between the node and the user device in an ongoing and continuous manner and monitoring a device-to-location proximity or distance of the user device to a predetermined location. The state machine software module 223 includes instructions for determining a user device status in response to at least one of the node-to-device communications and the device-to location proximity or distance. The alerter software module 222 includes instructions for activating a policy in response to at least one of the mobile device status or the smart device status. In some cases, the node-to-device communications between the node and the user device comprise a measure of proximity or distance between the node and the user device.

The node may be one of a plurality of identifiable elements and the device scanner software module may include instructions for monitoring node-to-device communications between each node in the plurality of identifiable elements and the user device. Additionally, the state machine software module 223 includes instructions for determining a unique user identifier, signature, or fingerprint in response to a plurality of node-to-device communications, each of the node-to-device communications corresponding to the communications between a single node and a device in the plurality of node-to-device communications corresponding to the node-to-device communications between a node in the plurality of identifiable elements and the user device, and determining the node status and the user device status in response to the unique user identifier, signature, or fingerprint.

The user interface software module includes a configuration activity software module 216 that includes instructions for providing a user interface on the user device and displaying, on the user interface 210, a node identifier associated with each node in the plurality of identifiable elements and the node-to-device communications of each node having a node identifier. Additionally, the device scanner software module 221 includes instructions for scanning the node and determining a node identifier thereby. The state machine software module 223 includes instructions for defining a characteristic location associated with the user. The definition of the characteristic location may include at least one of, for example, a geolocation corresponding to a physical location, a predetermined wireless communication network, and the unique user identifier, signature, or fingerprint. Referring back to FIG. 1D, the subject device establishes a characteristic location at 165, which is optionally designated as a safe zone at 166.

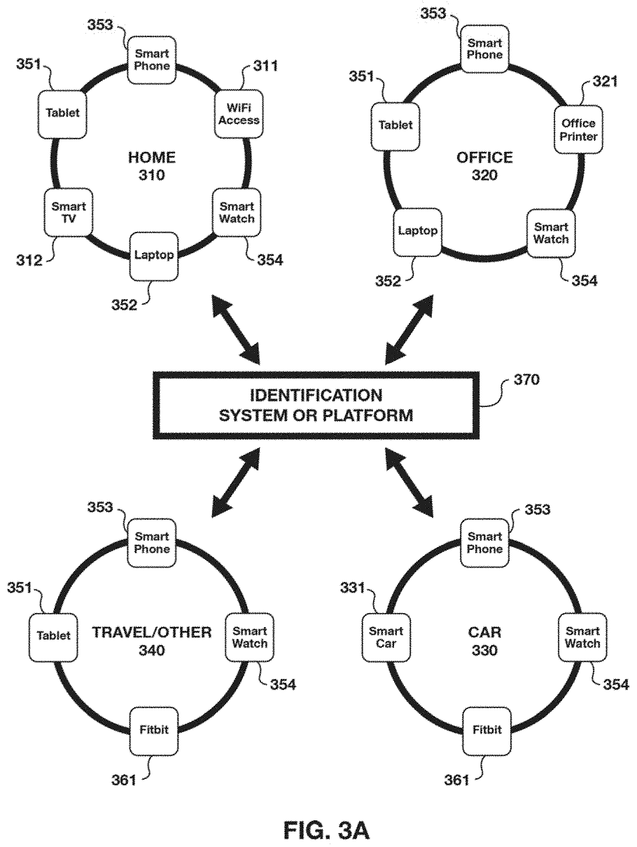

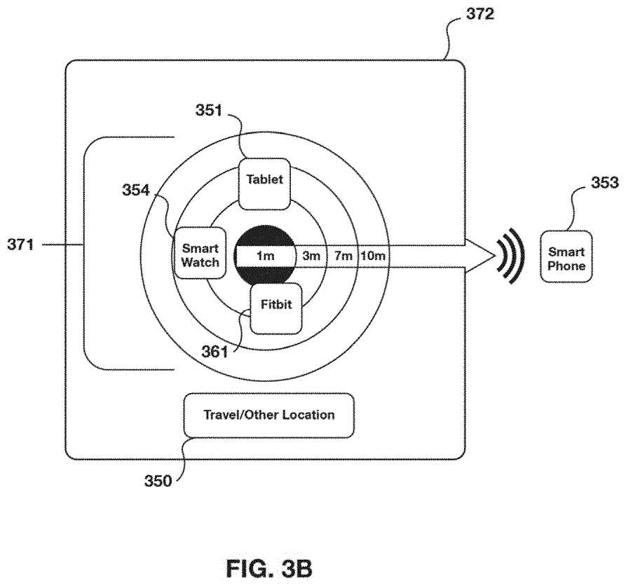

FIG. 3A shows that establishing a characteristic location in some instances includes designating the characteristic location as a home or residence 310, an office 320, a car or other vehicle 330, or a travel or other transit state 340. The fixed-location node is then associated with the designated characteristic location, i.e., with the residence, the office, the vehicle, or the transit state. Furthermore, the characteristic location is designated in response to the association or lack of association of the fixed-location node, such as the case in designating a travel or other transit state.

As illustrated in FIG. 3A, a characteristic location includes a plurality of characteristic locations and the plurality of characteristic locations include at least one of, for example, a residence, an office, a vehicle, and a transit state. Additionally, there may be any number of characteristic locations that include a plurality of residences, offices, vehicles, and any other location that may be associated with a user.

Referring back to FIG. 2A, the state machine software module 223 includes instructions for determining that the node status or user device status is lost or stolen (via the method shown for example in FIG. 1E) in response to designating a characteristic location as a safe zone, determining that the subject device has moved away from the user beyond a predetermined lost threshold, and determining that the subject device has moved away from the safe zone beyond a predetermined safe zone threshold.

In some embodiments, the state machine software module 223 includes instructions for determining that the user device status is forgotten in response to determining that the user has moved away from the node beyond a predetermined forgotten threshold.

The alerter software module 222 includes instructions for activating an alert or an alarm on the node or on the user device (via the method shown for example in FIG. 1F) in response to determining that the subject device status is lost or stolen. Additionally, the alerter software module 222 includes instructions for activating an alert or an alarm on the node or on the user device in response to determining that the user device status is lost or stolen. The alerter software module 222 also includes instructions for deactivating the activated alarm on the node or on the user device in response to at least one of, for example, determining that the user device has moved closer to the user to a point within the predetermined lost threshold, determining that the user device has moved closer to the safe zone to a point within the predetermined safe zone threshold, and entering a password on the user device.

The platform includes a sync service software module 240 that includes an authenticator software module 241 having instructions for authenticating a password entered on the user device to deactivate the activated alarm and a status reporter software module 242 that includes instructions for reporting the node status or the user device status. The alert service software module 230 includes a lock software module 232 that includes instructions for locking the user device in response to determining that the user device has been lost or stolen. The alert service software module also includes a notifier software module 233 and an event reporter software module 235. The notifier software module 233 includes instructions for sending an alert to an event reporter software module 235 in response to determining that the user device has been lost or stolen, while the event reporter software module 235 includes instructions for recording and displaying the user device status in response to the received alert.

The alert service software module 230 also includes, in some instances, a wipe software module 231 that includes instructions for activating a self-destruct mechanism on the user device when the user device status is determined to be lost or stolen. The self-destruct mechanism is activated in response to at least one of, for example, determining that an elapsed time has exceeded a predetermined elapsed time threshold, determining that a number of failed attempts to enter a password on the user device has exceeded a predetermined password attempt threshold, and determining that the user device has been powered off. A counter to determine the elapsed time is initiated upon determining that the user device has been lost or stolen.

The subject device allows the implementation or activation of a comprehensive set of policies with associated security measures. The monitoring service is always on and may enact policies and security measures automatically based on device measurements and locations. In particular, a series of possible actions is set into motion, including but not limited to: sending or activating an alarm or an audible alert through all devices to a possible loss or theft of device, tracking or monitoring alarms or alerts, deactivating alarms or alerts, locking a device, deleting or encrypting device data, restricting access to the device or an app, document, program or website on or through that device, and turning on or off access to a safe or unknown/suspect network. In addition, the security features of locking a device and deleting or encrypting of device data are unique in the subject device and survive the powering off of the device and a reboot of the device, including for example, if the device is re-powered outside of an accessible network. In other words, turning off the phone does not turn off the protection features.

FIG. 2B shows an alternative schematic view of a system 250 including various safe zones 278, 290, 254 and 280 for a subject device 260, not drawn to scale. The subject device 260 may be a mobile communications device including at least one processor 262 coupled to a memory 264 holding program instructions that when executed by the processor 264 cause the device 260 to perform any or all or the operation described herein for monitoring and securing the subject device. The subject device 260 may perform these operations automatically alone or in cooperation with one or more remote servers 298, which may be real or virtual (e.g., an instance operating in a cloud server environment). Although the device 260 can make use of remote services for heavy processing, it should be capable of at least basic automatic operations when operating alone so that the security of the subject device 260 is not compromised when a connection to the remote server 298 is not available.

The subject device 260 may further include a graphics processing unit 268 coupled to an interactive display 269, for example, a touchscreen; a wireless transceiver coupled to an antenna 265; an and audio transducer 267 (e.g., speaker) coupled to the CPU 262 via an audio driver (not shown). Components of the subject device 260 may be coupled to one another using an internal bus or other coupling. Examples of a form factor for a subject device include a smartphone, laptop computer, notepad computer, smart watch, and similar portable computing devices. In the illustrated example, the subject device 260 is located within a home zone 290 shared with various other fixed and mobile nodes, peer ones of which may similarly be operating the security application and thus, may be also subject devices of their own. The home zone 290 may be populated by any non-zero number of nodes. Not counting the wearable nodes in the user zone 278, the home zone in this example may also include a notepad computer node 292, a peer smartphone node 294, an Internet-of-Things (IoT) equipped refrigerator 296, and a wireless router/modem 295 providing a local WiFi signal and connection to the Internet via a wide area network 252. In addition to connections with these nodes, the subject device 260 may define the home zone in part by a geographic location from a GPS receiver or the other locating module.

The subject device 260 may define security policies and measures as described elsewhere herein with respect to the zones and all their nodes, of which the illustrated nodes provide a few illustrative, non-limiting examples. The subject device 260 may define a user zone 278 based on proximity to a registered user of the device 260, using biometric data (e.g., fingerprint, eye or face imaging, heartbeat, respiration or pulse indictors) and connections to one or more wearable nodes, including, for example, smart wireless headphones or earbud 272, a smartwatch or fitness tracker 274, and an RFID-chipped credit or debit card or special purpose token device 276. When in proximity to the user 270, the subject device 260 may recognize that it is operating in a safe zone no matter where the user may be located. Thus, the user represents an example of a mobile safe zone 278.

Another example of a mobile safe zone 254 is provided by a motor vehicle 256 that may be owned, leased, or temporarily in use by the user 276. The motor vehicle 256 may include a smart cellular component capable of connecting to a cellular network 258 and from thence to the Internet via a WAN 252. In addition, the vehicle 256 may include a Bluetooth or similar short-range interface for direct connection to the subject device 260. The subject device 260 may enact a “safe” policy when detecting it is in both the user zone 278 and vehicle zone 254, and a “lost” or “forgotten” policy when it detects it is in the vehicle zone 254 but not in the user zone 278, depending on the status of relationship between the user 270 and vehicle 256 (e.g., owner or mere passenger).

An office zone 280 provides another example of a characteristic safe zone like a home zone, containing its own collection of nodes such as, for example, a second router/modem 282 connected to the WAN 252 and servicing office equipment for example a printer 288, voice-over-Internet phone 286, and laptop or personal computer 284. The subject device may recognize one or more characteristic working zones 280 for any given user, based on user configuration of such zones, by automatic detection using a rules-based and/or machine learning algorithm, or any useful combination of the foregoing.

For further examples of operation in various safe zones or other environments, in each of the defined locations shown in FIG. 3A, the registered devices (nodes) may communicate with each other through at least one the subject device 370 (“identification system and platform”). FIG. 3A shows various examples of mobile and smart devices including a tablet 351, a laptop 352, a smart phone 353, and a smart watch 354, along with an exemplary node such as a Fitbit 361, and various examples of fixed-location nodes including Wi-Fi access at a home location 311, a smart television or TV, an office wireless printer 321, and a smart car 331. In this case, the subject device uses the various fixed-location nodes together with the communication between the mobile nodes and peer devices to define each location and the user-defined policies that are active. Here, the smart TV 312 together with the other devices and nodes connected in the home location 310 are used by the subject device 370 to define the characteristic location as a user's home 310, the office wireless printer 321 together with the other devices and nodes connected in the home location 310 define the characteristic location as a user's office 320, and the smart car together with the other devices and nodes connected in the home location 310 define the characteristic location as a user's car 331. In the case of a user in transit or traveling 340, the absence of any fixed-location or location specific device together with the communication between the user's other nodes define the characteristic location as a travel or other transit state that is not home, not office and not car, and then the subject device sets appropriate policies in place.

In some embodiments, the nodes that are registered and used through the system, platform or mobile application are standard, off-the-shelf wireless, mobile or smart devices, identifiable nodes having communication or connectivity capabilities including wearable devices, or fixed location devices. These nodes are for example, Android™- or Apple™-based and include but are not limited to: IoT devices, laptops, iPads™ or other tablets, iPens™ and other wireless tablet tools, wireless iPods™ and other like MP3 players, wireless printers, wireless data storage devices (such as Apple™ Airport Time Capsule), Wi-Fi access points, smart phones, smart watches, Fitbit and other wearable activity monitoring devices, Bluetooth devices, such as headsets, headphones, keyboards, add-on Bluetooth signal, emitters, Google Home™, Amazon Echo™, Alexa™ and other like home assistants, media players such as Roku™, smart TV and other smart home appliances, smart Blu-ray and other like media players, Nest and other wireless security cameras, Nest™ and other like smart thermostats, Gecko™ spa and other wireless home spa controls, Wemo and other wireless light and appliance controls, Kevo™ and other wireless door lock control and other wireless door lock control system key fobs, Tile™ and other property location tags, smart cars and other smart vehicles, and smart car key fobs. In some cases, the subject device scans each node to determine a node identifier for each node that is selected or registered.

In some embodiments, the subject device creates a web or session of regular communication with these nodes. For some fixed-location nodes, such as a wireless printer, the system uses the fixed location associated with or corresponding to the fixed-location node to identify the owner through a constant measurement of the distance or proximity or distance the nodes are from each other, and the physical location of these nodes. This process of using a unique combination of nodes, relative measurements between nodes and the definition of a characteristic location creates the unique user identifier, signature, or fingerprint for the device user or owner.

In some embodiments, the subject device performs an ongoing measurement of distances or proximities between selected or registered nodes. Using the ongoing measurement, the subject device monitors the nodes. Monitoring may include using the user's nodes as a proxy for the user, for example, by establishing a unique user identifier, signature, or fingerprint based on or in response to monitoring the user's nodes, the subject device determines and monitors the actual location of the user. By monitoring the location of the user and the location of each of the user's nodes, the subject device allows the user, device owner, or a corporate IT manager to customize and set into place security action policies based on or in response to changing distances or proximities between nodes and recognition of which nodes are stationary with respect to the user and which nodes are moving away from the user.

As described above, the subject device identifies which node is moving away from the other nodes. Indeed, the determination of whether a device is moving away from the user (or the user's proxy or unique user identifier, signature, or fingerprint as defined or established by the user's other devices such as identifiable nodes or wearable devices) are used by the system to determine the status of a device as safe, lost, safe but lost, stolen, airplane, or silenced as shown by the exemplary method shown in FIG. 1E. The status depends on or be in response to the location of nodes, whether they are in a characteristic location designated as a safe zone, and whether they are detected as moving out of a user defined security radius or threshold associated or corresponding to a safe zone.

FIG. 3B shows a collection of user nodes 371 (in this case, a tablet 351, a smart watch 354, and Fitbit 361) as establishing a unique user identifier, signature, or fingerprint that are associated with the user being in a transit/travel state or some other characteristic location 350. In this scenario, a user device, shown here as a smart phone 353, is being detected as moving away from the user's other devices 370 and/or the characteristic location 350. The characteristic location 350 is designated as a safe zone with an associated security radius or threshold 372, which in this case is shown as 10 meters. The security radius or threshold 372 is defined for example by a corporate IT manager for an office location, and a specific policy and security measures are implemented for a selected user device with respect to the office location. The policy and security measures include activating an audible alert through all devices to a possible theft of a device, locking the device, restricting access to the device if a correct solution or password is not entered or if communication between the smart phone and the user's other devices is not successful within a defined timeframe.

In this case, the policy is set to allow access to the smart phone via communication with other associated devices within the security radius or threshold of 10 meters if a correct password is successfully entered within 120 seconds, at which point the smart phone is unlocked and normal operations resume. Alternatively, if the correct password is not entered or if communication between the smart phone and the user's other devices within the security zone is not successful within the 120 seconds timeframe, the policy specifies that data on the smart phone will automatically be deleted. As another option, the policy specifies that only a certain number of attempts at entering the correct password will be accepted before triggering a lockout of the device or deletion of the device contents or data. For example, the policy is set to accept up to four password attempts before locking the device or wiping its contents.

As shown in FIG. 3B, as the smart phone moves away from the other user devices that define the office location, passing or exceeding the 10-meter security radius or threshold set by the corporate IT manager in this case, a policy is activated to initiate, activate, or set into play various security measures as described above.

Accordingly, for another example, if the user is outside of the user's home, office or car locations and the subject device identifies that a node such as the user's wireless headset is moving away from a user device such as the user's smart phone, the subject device detects and identifies the movement as the user leaving the user's phone behind. The subject device alerts the user to the situation that the user's phone has been left behind and invokes a policy or set forth security measures if the user's headset continues to move outside of the security radius or threshold.

On the other hand, if the subject device detects or identifies that the user's smart phone is moving away from the user's headset, the subject device identifies or processes the movement as a possible theft. The subject device alerts the user of the possible theft and invokes a policy or set forth security measures if the user's smart phone continues to move outside of the security radius or threshold.

As described above, by performing an ongoing measurement of distances between selected or registered devices, the subject device allows the user or a corporate IT manager to define and set in place action policies based on changing distances between devices. Whereas Bluetooth devices may communicate for distances up to 30 meters, the subject device allows the user or corporate IT manager to set a distance or threshold of between 1 and 30 meters as a security radius or threshold. Should a device leave the security radius or cross the threshold, appropriate, predefined actions automatically take place. In addition to setting a security radius or threshold, the device owner or corporate IT manager also defines a safe zone. For example, a user's home may be defined as a safe zone such that if the user moves away from the user device such as a smart phone for a distance outside of the security radius, the subject device will recognize this movement not as a theft or loss of a device but simply as movement within a safe zone. No security action will be taken and no alert will be activated as long as the device remains in communication with other registered devices and with the subject device.

Notably, the parameters of security radius or distance threshold, timeframe threshold for entering a password, and number of attempts for entering a correct password is designated by the user. The subject device and associated servers may be configured to provide a selection of discrete options for a security radius, such as for example 1 meter, 2 meters, 3 meters, or 10 meters, or is set for any value for a security radius on a discrete or continuous scale. Additionally, the system is configured to provide a selection of discrete options for a timeframe, such as for example, 0 seconds, 30 seconds, 60 seconds, 90 seconds, 120 seconds, 150 seconds, and 180 seconds, or is set for any period for a timeframe on a discrete or a continuous scale. Similarly, the system is configured to provide a discrete set for the number of attempts such as for example, 1 attempt, 2 attempts, 3 attempts and 4 attempts or may be configured to provide any value for the number of attempts. The embodiments described herein are not limiting as each of these parameters is customized or set to any value or set of values with respect to the system described herein. The elements of policy are not pre-packaged or static. Rather, they are fully customizable by the user to reflect personal needs and situations, corporate policy, industry requirements, and enactment of any one or more policies is based on real time conditions, data, and actions as defined by the user and recognized through the application.

As described above, the system and platform allows the user, device owner, AI algorithm or a corporate IT manager to customize and set into place a number of security action policies based on or in response to changing distances or proximities between the subject device and connected nodes and recognition of which nodes or device are stationary with respect to the user and which node or device are moving away from the user. FIGS. 4A-4H illustrate examples of screenshots in an example of a user interface of a subject device, illustrating various operations, parameters, inputs, outputs and machine or system states. FIG. 4A shows the system configuration activity software module interface on a cell phone 410 of an exemplary embodiment. Standard elements of a hosting cell phone include, among other things, a Bluetooth indicator 411, a Wi-Fi signal strength indicator 412, a network connectivity strength indicator 413, a battery charge indicator 414, a clock 415, a previous screen button 416, a home button 417, and a web screens button 418.

The system configuration activity software module interface's main screen 420 provides a visual summary of the six-step security action policies and their status which may be defined and enabled by the user, device owner, or a corporate IT manager based on any of a number of set or defined parameters. In some embodiments, the software module interface's main screen 420 includes: an indicator of the application 430, whether the security action policies have been defined and completed 431, and a status indicator 432 as to whether the application 430 is enabled/on or not; an indicator of the security action policy pertaining to user identity devices 440, showing the number of user devices registered 441 through the system configuration activity software module interface; an indicator of the security action policy pertaining to safe networks 450, showing the number of safe networks registered 451 through the system configuration activity software module interface, and a status indicator 452 as to whether this security action policy is enabled/on or not; an indicator of the security action policy pertaining to defined locations 460, showing the current location 461, if recognized as a location registered through the system configuration activity software module interface, and a status indicator 462 as to whether this security action policy is enabled/on or not; an indicator of the security action policy pertaining to security radius 470 for the defined location 461, showing the defined measure 471 of the security radius, as registered through the system configuration activity software module interface, and a status indicator 472 as to whether this security action policy is enabled/on or not; and an indicator of the security action policy pertaining to self-destruction of the user device's data 480, showing the defined user device status 481, as registered through the system configuration activity software module interface, to which the self-destruct policy pertains, and a status indicator 482 as to whether this security action policy is enabled/on or not.

FIG. 4B shows the system configuration activity software module interface data entry and display screen 421 which are used for the registration of user identity devices for the security action policy pertaining to user identity devices 440 of an exemplary embodiment. The data entry and display screen 421 for the registration of user identity devices for the security action policy pertaining to user identity devices 440 have two user options: add an available device 442, and remove a registered device 443. Upon completion of adding or removing a user identity device for the security action policy pertaining to user identity devices 440, the user selects the return to main screen option 422.

The platform includes a device wizard 490, in some instances, to assist the user in identifying and adding available user identity devices, as shown in FIG. 4C. In this embodiment, the device wizard communicates with available devices and presents each device's public identifying information, which includes: the device's broadcasting identifier 491; the device's manufacturer/make 492; the device's signal strength 493; the device's model 494; and the device's serial number 495. Using this information, the user determines if the displayed device should be a registered user identity device. If so, the user enters an identifying device name 496 and, through a drop-down menu of location options 497, select the location to which this device is to be associated, and then press the add/plus symbol 498. Upon completion of adding a user identity device for the security action policy pertaining to user identity devices 440, the user selects the return to main screen option 422.

FIG. 4D shows the system configuration activity software module interface data entry and display screen 421 and the remove registered device option 443 for the security action policy pertaining to user identity devices 440 (nodes) of an exemplary embodiment. In this example, the remove registered device element 443 displays the registered user identity devices (nodes) by their identifying device name 444 along with their defined location 445. The user removes any such device from the list of user identity devices 440 by pressing the remove/minus symbol 446. Upon completion of removing a user identity device for the security action policy pertaining to user identity devices 440, the user selects the return to main screen option 422.

FIG. 4E shows the system configuration activity software module interface data entry and display screen 421 which is used to add available networks and remove saved networks for the security action policy pertaining to safe networks 450 of an exemplary embodiment. In this example, the add available network element 452 displays broadcast name of the network 454 to which the user identity device is currently connected, as shown in connection status 455. The user registers this as a safe network by entering the defined location of such network through a drop-down menu of location options 456, and then pressing the add/plus symbol 453. In this example, the remove saved network element 457 displays broadcast name of each registered safe network 459, its current connection status 459A, and its defined location 459B. The user removes this from the list of registered safe networks by pressing the remove/minus symbol 458. Upon completion of either adding or removing a safe network for the security action policy pertaining to safe networks 450, the user selects the return to main screen option 422.

FIG. 4F shows the system configuration activity software module interface application data display screen 423 which shows a current status summary of the registered user identity devices of an exemplary embodiment. In this example, the registered user identity device cell phone 410 has been associated with the defined location 460 of office 461, and the devices connected element 462 shows the number of connected devices display 463 which reports that two registered user identity devices are connected through the application and are in communication with each other. In this example, the connected and registered user identity devices are the cell phone 410 and the connected device (node) 465 “123trader printer,” which is associated with the defined location office 466 and shown to be connected by the connection status symbol/checkmark 464. Upon completion of reviewing the application data display screen 423, the user may select the return to main screen option 422.

FIG. 4G shows the system configuration activity software module interface data entry and display screen 421 which is used to review, add and/or remove a defined security radius for the security action policy pertaining to security radius 470 of an exemplary embodiment. In this example, the element (node) security radius 470 shows a status indicator 472 as to whether this security action policy is enabled/on or not and shows the number of saved security radius settings 473, are registered through the application. Through the add saved radius element 474, a user defines a security radius using the distance slide 475, assign that security radius to a defined location using a drop-down menu of location options 476, and register these entries through the application by pressing the add/plus symbol 477. The change/remove saved radius element 478 displays a list of all saved security radius settings registered through the application, showing the saved radius by radius distance 479 and the associated defined location 479A. To remove a saved radius, the user pressing the remove/minus symbol 479B. Upon completion of either adding or removing a saved radius for the security action policy pertaining to security radius 470, the user selects the return to main screen option 422.

FIG. 4H shows the system configuration activity software module interface data entry and display screen 421 of an exemplary embodiment, which is used to set a security action policy, in this case, pertaining to self-destruction of the user device's data 480. The self-destruct element 480 has three main policy protocols which are defined by the user: the triggering user identity device loss/theft status 483; the security timer duration 484B; and the number of password failures 485B. The security action policy pertaining to self-destruction of the user device's data 480 has a status indicator 482 which shows whether this security action policy is enabled/on or not. The user defines if and when the security action policy pertaining to self-destruction of the user device's data 480 should take place by selecting among the options for user identity device loss/theft status 483. In this example, the user has defined the security action policy pertaining to the self-destruction of the user device's data to take place only in the event that the application identifies the registered user identity device being in a theft scenario. A second parameter of the security action policy pertaining to the self-destruction of the user device's data 480 is a defined span of time during which, once the application determines that a loss or theft has occurred and the alert has sounded, the user enters the correct password to abort the self-destruct action. The security action policy pertaining to the security timer element 484 displays a status indicator 484A which shows whether this security action policy is enabled/on or not, and displays the defined security time action window 484B registered through the application. In this example, the user has defined the security time action window 484B as 150 seconds by selecting that time span from the security timer sliding scale 484C. A third parameter of the security action policy pertaining to the self-destruction of the user device's data 480 is a defined number of password entry failed attempts after which, once the application determines that a loss or theft has occurred and the alert has sounded, the self-destruct action immediately takes place. The security action policy pertaining to the password failures element 485 displays a status indicator 485A which shows whether this security action policy is enabled/on or not, and displays the defined number of password entry failed attempts 485B registered through the application. In this example, the user has defined the number of password entry failed attempts 485B as 3 attempts by selecting that time span from the number of password entry failed attempts sliding scale 485C. Upon completion of registering the triggering user identity device loss/theft status 483, the security timer duration 484B; and the number of password failures 485B for the security action policy pertaining to self-destruct 480, the user selects the return to main screen option 422.

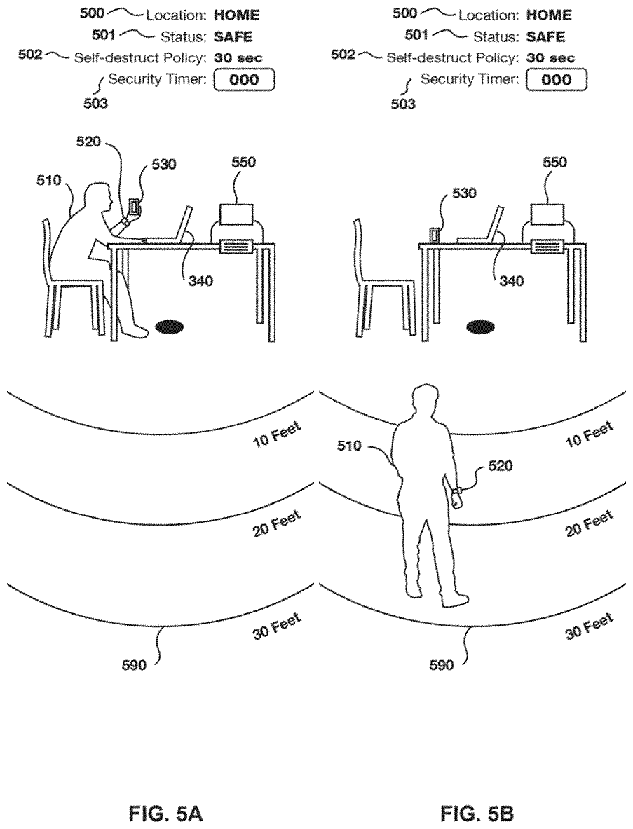

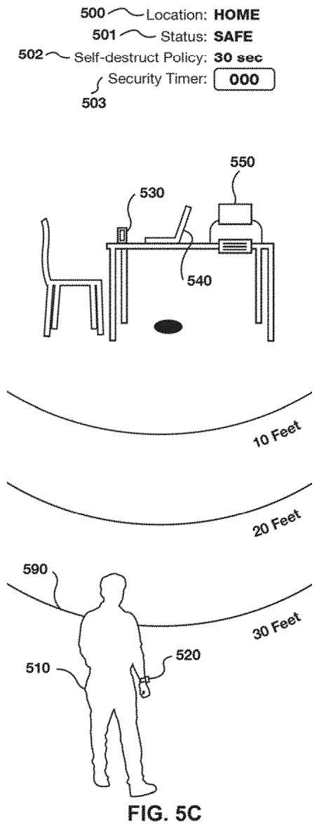

The active protection of any one user identity device is dependent on many different elements, including the number and type of registered identifiable nodes, the security action policies defined and enabled by the user, the policies as they pertain to defined locations, and the various actions that may or may not take place with a device, within a location and the steps that may be taken to address an enacted alarm and an enabled and active security action policy. FIGS. 5A-9D show just a few examples of possible loss and theft scenarios and how the application can operate on a subject device, based on defined security action policies of an exemplary embodiment. The subject device may perform operations entirely locally or may operate in cooperation with a remote server.

FIGS. 5A-5C show a scenario of a user 510 working at the defined location 500 of home where elements of the defined security action policies for this defined location are that self-destruct security timer element 502 is defined as 30 seconds, and the defined security radius 590 is 30 feet. In FIG. 5A, the user 510 is working at a desk in the defined location 500 of home and has the registered user identity devices, smart watch 520, smart phone 530, laptop 540, and printer 550. As a fixed-location node, printer 550 makes up part of the defined and registered information which establishes the defined location 500 as home. Currently, as all registered devices are communicating with one another within the defined location 500 of home, and as all devices are not moving in relation to one another, the user identity device's loss/theft status 501 of the subject smart phone 530 is safe. FIG. 5B shows the user 510 with smart watch 520 leaving the desk and, thus, moving away from the subject user identity device smart phone 530, but still within the defined security radius 590 of 30 feet. FIG. 5C now shows the user 510 with smart watch 520 moving away from the subject user identity device smart phone 530, and outside the defined security radius 590 of 30 feet. However, in this example because the defined location 500 of home is considered a safe zone, while communication between the devices is maintained, the user identity device loss/theft status 501 of the subject smart phone 530 remains safe, and no alerts are sounded, the security timer 503 is not activated, and no defined security action policy for self-destruct are enacted.

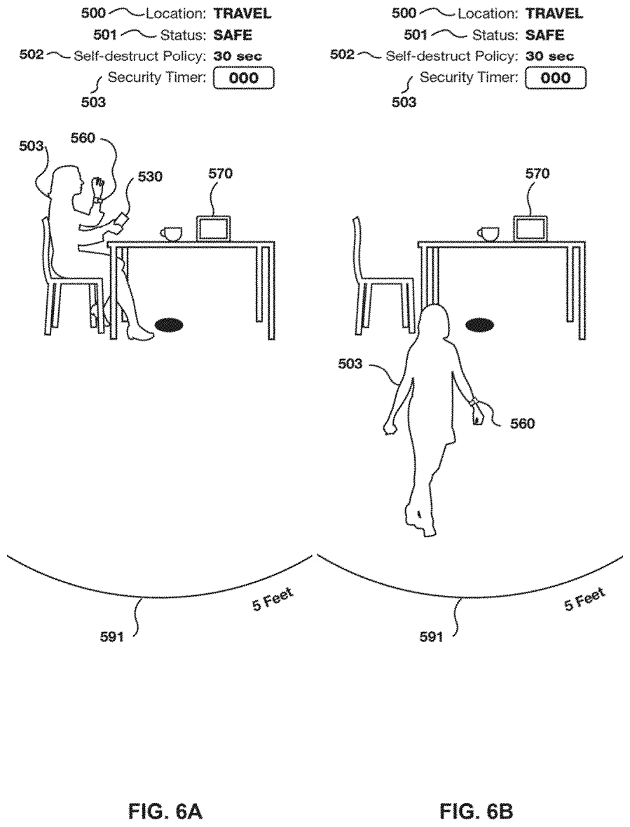

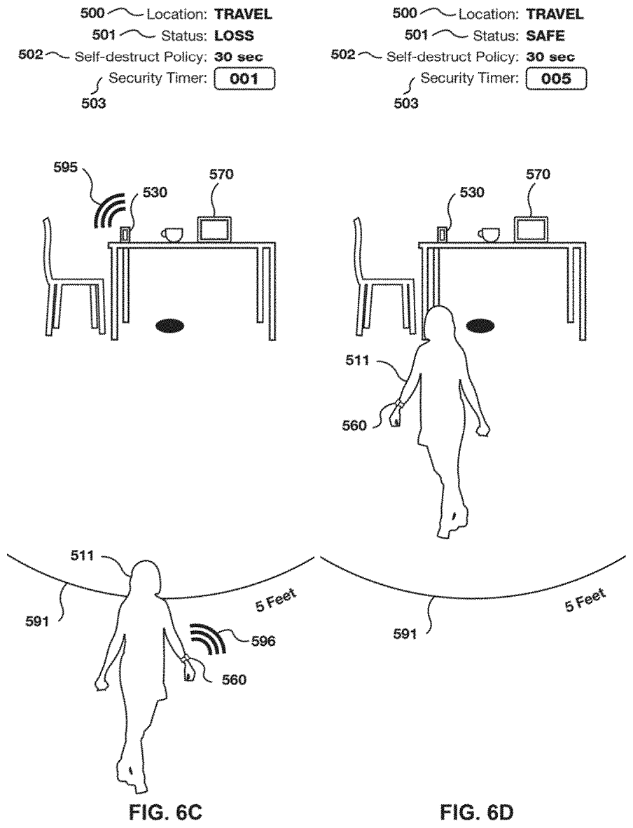

FIG. 6A-6D show a scenario of a user 511 at a coffee shop with the defined location 500 of travel where elements of the defined security action policies for this defined location are that self-destruct security timer element 502 is defined as 30 seconds, and the defined security radius 591 is five (5) feet. In FIG. 6A, the user 511 is sitting at a table in the defined location 500 of travel and has the registered user identity devices, Fitbit 560, smart phone 530, and tablet 570. At this time, as all registered devices are communicating with one another within the defined location 500 of travel, and as all devices are not moving in relation to one another, the user identity device's loss/theft status 501 of the subject smart phone 530 is safe. FIG. 6B shows the user 511 with Fitbit 560 leaving the table and, thus, moving away from the subject user identity device smart phone 530, but still within the defined security radius 591 of five (5) feet. FIG. 6C now shows the user 511 with Fitbit 560 moving away from the subject user identity device smart phone 530, and outside the defined security radius 591 of five (5) feet. At this point, based on communication between the devices, the application determines that the user 511 is moving away from the smart phone 530 and has moved outside the defined security radius 591 of five (5) feet, and the so that the user identity device's loss/theft status 501 of the subject smart phone 530 is now classified as a loss scenario. At the same time, the security action policy for self-destruct is enacted, the security timer 503 starts, here showing 0:01 seconds, and audio and text alerts, 595 and 596, are enacted on both the subject smart phone 530, and the Fitbit 560. FIG. 6D shows that in response to the alerts, the user 511 returns to the table where the subject smart phone 530 was left. As the user 511 crosses inside the defined security radius 591 of five (5) feet, and because the devices are still communicating with each other and because the security timer 503 shows an elapsed time of five (5) seconds, less than the defined self-destruct security timer element 502 of 30 seconds, the alerts 595 and 596 are aborted and the user identity device's loss/theft status 501 of the subject smart phone 530 is now classified as safe. Because this is an example of a possible loss scenario and the defined self-destruct security timer element 502 threshold of 30 seconds was not surpassed, no entry of a password on the subject smart phone 530 is needed to abort the defined security action policies.

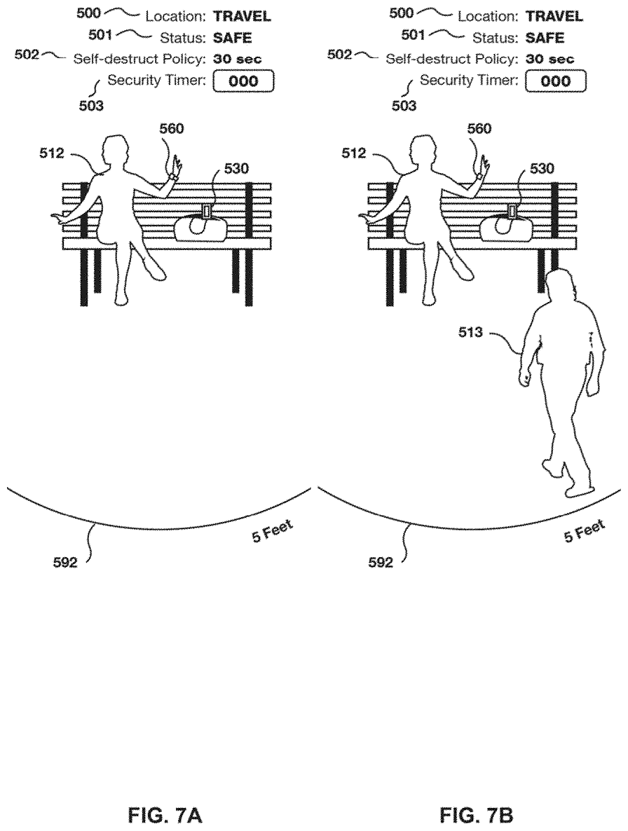

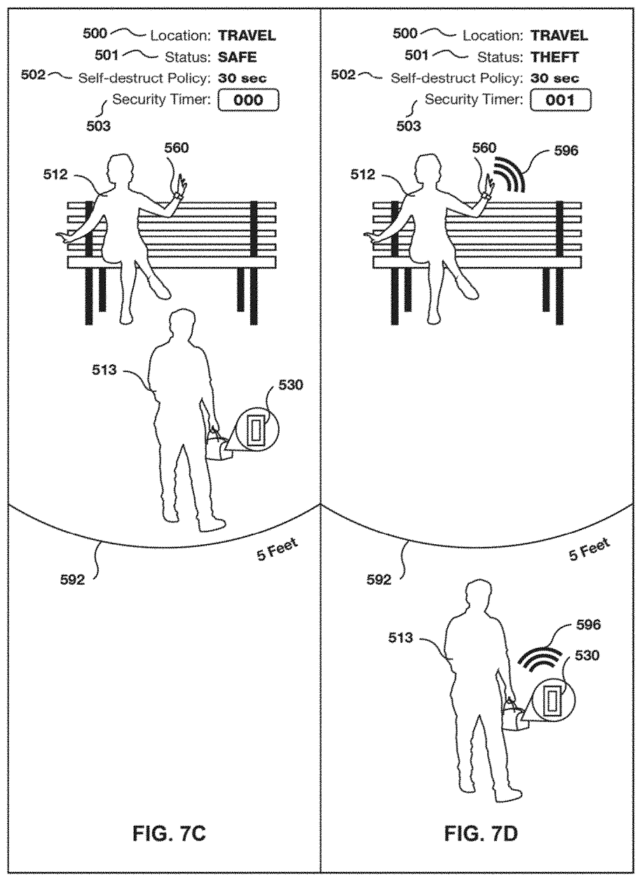

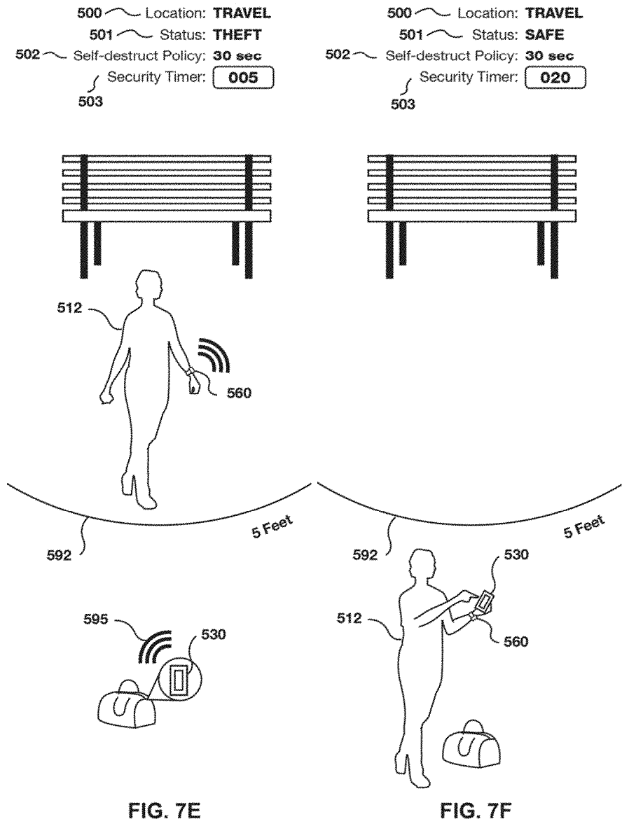

FIGS. 7A-7F show a scenario of a user 512 on a park bench with the defined location 500 of travel where elements of the defined security action policies for this defined location are that self-destruct security timer element 502 is defined as 30 seconds, and the defined security radius 592 is five (5) feet. In FIG. 7A, the user 512 is sitting on a park bench in the defined location 500 of travel and has the registered user identity devices, Fitbit 560, and smart phone 530. At this time, as all registered devices are communicating with one another within the defined location 500 of travel, and as all devices are not moving in relation to one another, the user identity device's loss/theft status 501 of the subject smart phone 530 is safe. FIG. 7B shows the user 512 and the user's registered devices remaining on the bench while a person 513 enters the defined security radius 591 of five (5) feet. FIG. 7C shows the person 513 taking the purse of user 512 which contains the subject smart phone 530. FIG. 7D shows that based on communication between the devices, the application determines that the smart phone 530 is moving away from user 512 and has moved outside the defined security radius 591 of five (5) feet. At this time, the user identity device's loss/theft status 501 of the subject smart phone 530 is now classified as a theft scenario, the security action policy for self-destruct is enacted, the security timer 503 starts, here showing 0:01 seconds, and audio and text alerts, 595 and 596, are enacted on both the subject smart phone 530, and the Fitbit 560. FIG. 7E shows that in response to the alerts, the person 513 drops the purse which contains the smart phone 530 and the user 512 leaves the bench to retrieve the items, the security timer 503 shows an elapsed time of five (5) seconds. As the user 512 crosses outside the defined security radius 592 of five (5) feet, the security timer 503 shows an elapsed time of five (5) seconds, less than the defined self-destruct security timer element 502 of 30 seconds. The user 512 picks up the subject smart phone 530 and enters the system password which ends alerts 595 and 596, aborts the defined security action policies, and changes the user identity device's loss/theft status 501 of the subject smart phone 530 to safe. Because this is an example of a possible theft scenario and the defined self-destruct security timer element 502 threshold of 30 seconds was not surpassed, entry of the password on the subject smart phone 530 was needed to abort the defined security action policies and prevent the self-destruct features from being fully enacted.

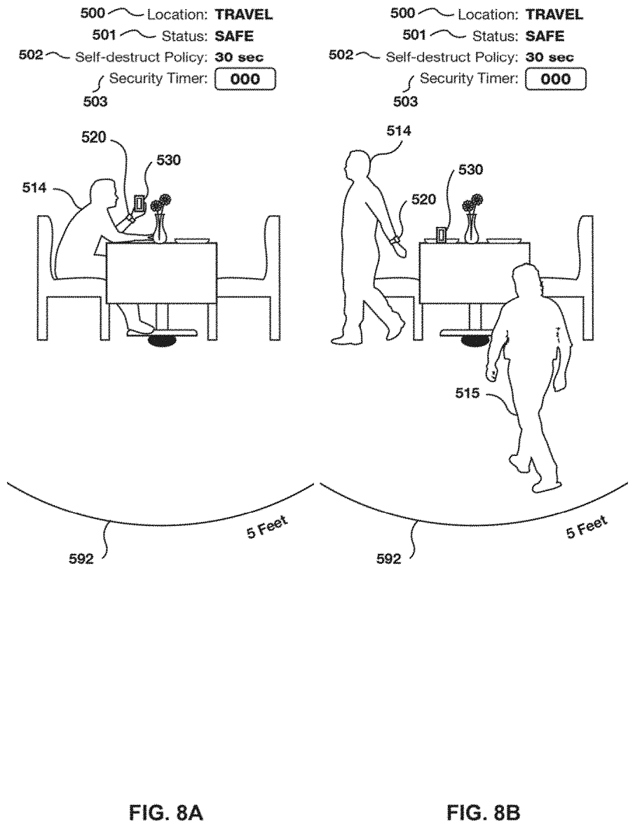

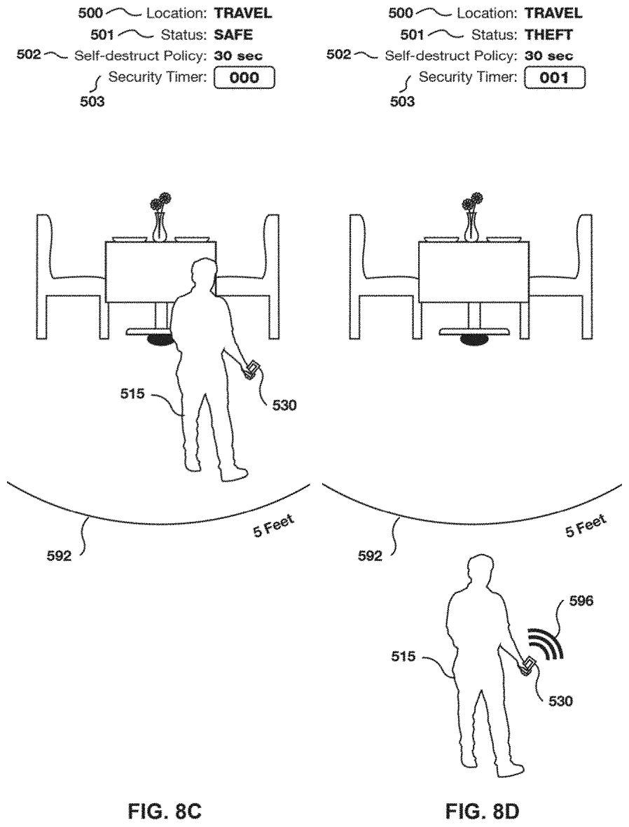

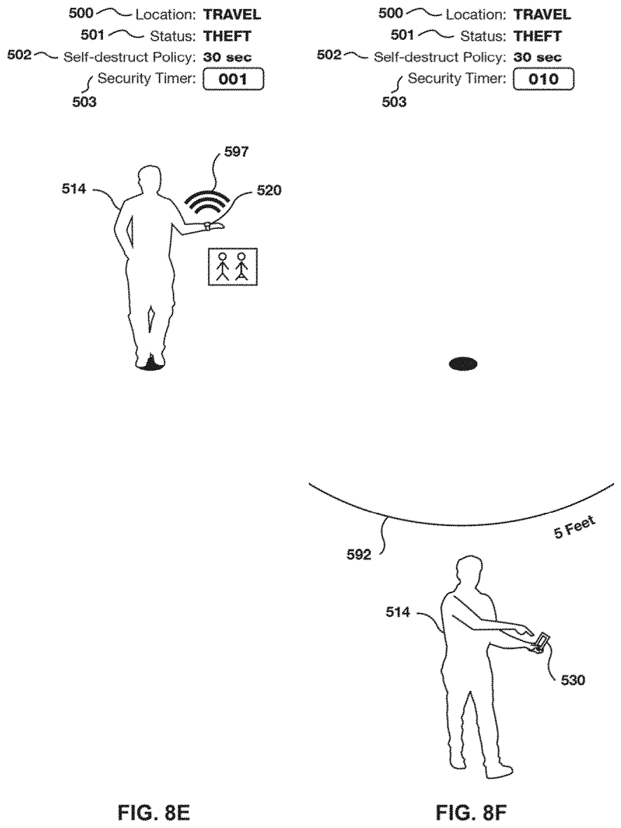

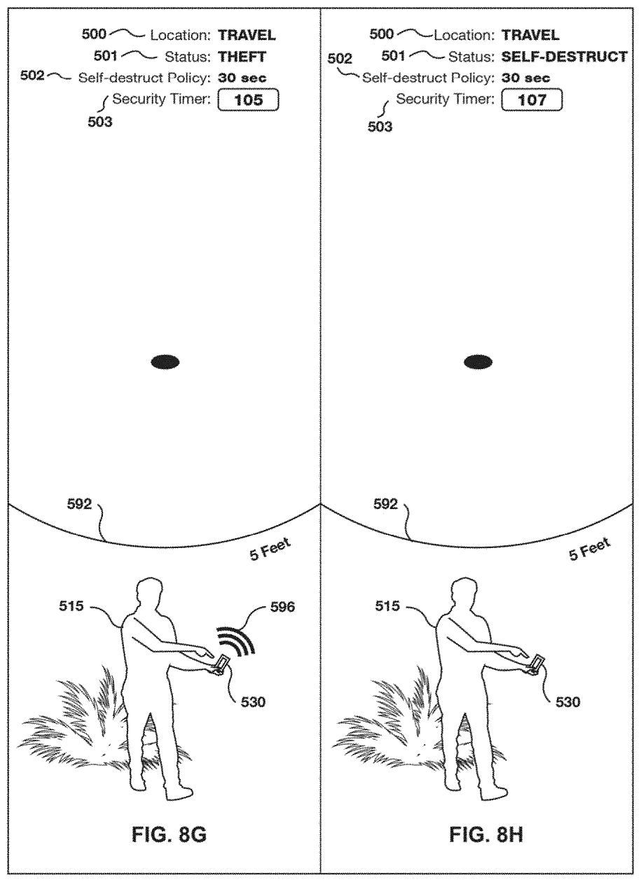

FIGS. 8A-8H show a scenario of a user 514 in a restaurant with the defined location 500 of travel where elements of the defined security action policies for this defined location are that self-destruct security timer element 502 is defined as 30 seconds, and the defined security radius 592 is five (5) feet. In FIG. 8A, the user 514 is sitting at a table in the defined location 500 of travel and has the registered user identity devices, smart watch 520, and smart phone 530. At this time, as all registered devices are communicating with one another within the defined location 500 of travel, and as all devices are not moving in relation to one another, the user identity device's loss/theft status 501 of the subject smart phone 530 is safe. FIG. 8B shows the user 514 leaving the table and the smart phone 530 remaining on the table while a person 515 enters the defined security radius 592 of five (5) feet. FIG. 8C shows the person 515 taking the subject smart phone 530. FIG. 8D shows that based on communication between the devices, the application determines that the smart phone 530 is moving away from user 514 and has moved outside the defined security radius 592 of five (5) feet. At this time, the user identity device's loss/theft status 501 of the subject smart phone 530 is now classified as a theft scenario, the security action policy for self-destruct is enacted, the security timer 503 starts, here showing one (1) second, and audio and text alerts 596, are enacted on the subject smart phone 530. At the same time, FIG. 8E shows the user 514 taking note of audio and text alerts 597 from his smart watch 520, alerting him to the possible theft of his smart phone 530. In FIG. 8F, the security timer 503 shows an elapsed time of 10 seconds, as the person 515 has left the immediate area outside the defined security radius 592 of five (5) feet, where he powers off the smart phone 230 in order to stop the alerts 596. In FIG. 8G, the person 515 has left the inside of the restaurant, outside the defined security radius 592 of five (5) feet, where he powers on the smart phone 230 and the text and audio alerts 596 resume. Even though the smart phone 230 was powered off, the security timer continues tracking elapsed time through the application, as the security timer 503 shows an elapsed time of 145 seconds, more than the defined self-destruct security timer element 502 of 30 seconds. In FIG. 8H, the application recognizes that the security timer 503 has an elapsed time of 147 seconds, more than the defined self-destruct security timer element 502 of 30 seconds, from the time the theft scenario was recognized, the loss/theft status 501 of the subject smart phone 530 was changed to self-destruct, and the defined self-destruct policy was engaged. Immediately, the defined self-destruct security policy is fully enacted, the smart phone 530 data is erased, the smart phone 530 is powered off and the user identity device's loss/theft status 501 of the subject smart phone 530 is changed to self-destruct.

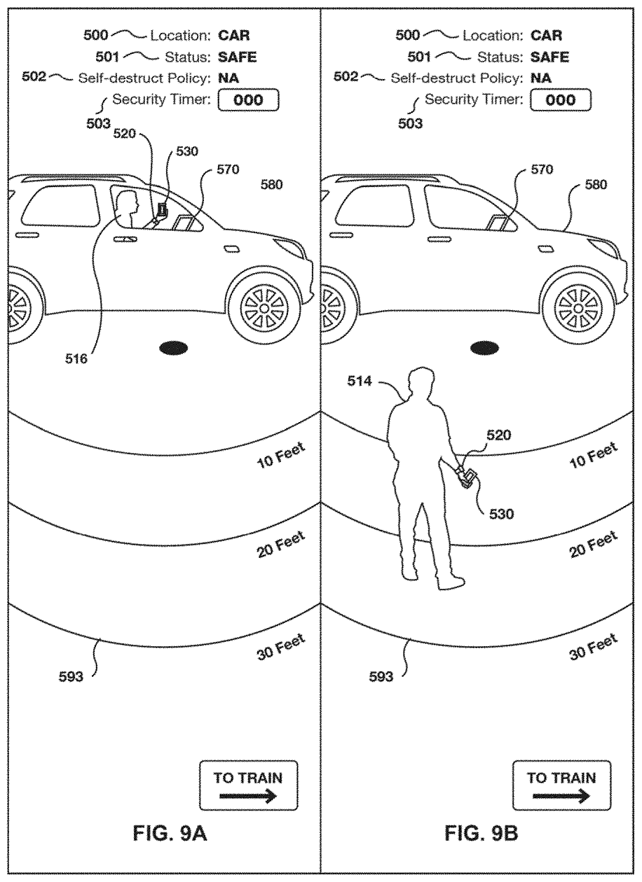

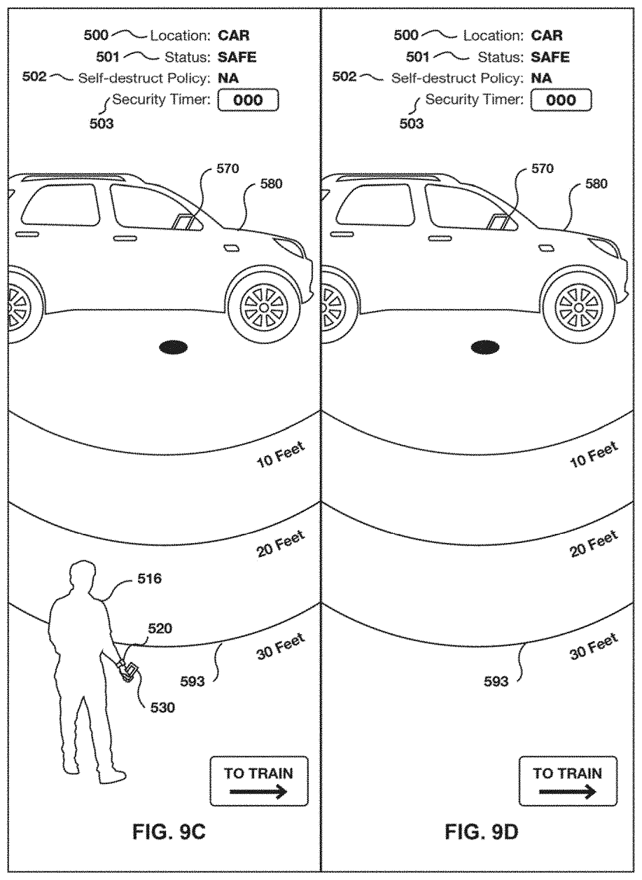

FIGS. 9A-9D show a scenario of a user 516 sitting in his parked car 580 at the defined location 500 of car where elements of the defined security action policies for this defined location are that self-destruct security timer element 502 is defined as NA/not applicable, and the defined security radius 593 is 30 feet. In FIG. 9A, the user 516 is seated in his car 580 in the defined location 500 of car and has the registered user identity devices, smart watch 520, smart phone 530, tablet 570, and car 580. As a fixed-location node, car 580 makes up part of the defined and registered information which establishes the defined location 500 as car. At this time, as all registered devices are communicating with one another within the defined location 500 of home, and as all devices are not moving in relation to one another, the user identity device's loss/theft status 501 of the subject tablet 570 is safe. FIG. 9B shows the user 516 with smart watch 520 and smart phone 530 leaving the car 580 and, thus, moving away from the subject user identity device tablet 570, but still within the defined security radius 593 of 30 feet. FIG. 9C now shows the user 516 with smart watch 520 and smart phone 530 moving away from the subject user identity device tablet 570, and outside the defined security radius 590 of 30 feet. However, in this example because the defined location 500 of car is considered a safe zone, as long as communication between the devices is maintained and the subject user identity device tablet 570 is not moving away from either this location or the car 580 as shown in FIG. 9C and at a later time shown in FIG. 9D, the user identity device loss/theft status 501 of the subject tablet 570 remains safe, and no alerts are sounded, the security timer 503 is not activated, and no defined security action policy for self-destruct are enacted.

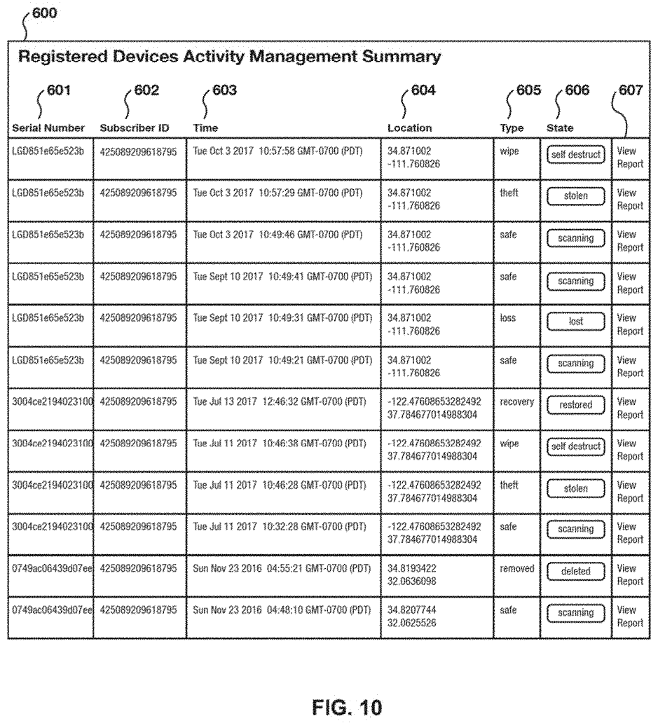

FIG. 10 shows the system registered devices activity management summary and display screen 600 which may be used by the user, device owner, or a corporate IT manager (e.g., using a server 298 as shown in FIG. 2B) to review current and historical state of multiple registered subject devices, and any defined policies or actions that were enacted in response to a triggering event or device state of an exemplary embodiment. The summary screen 600 shows and sort a listing of registered subject devices by serial number 601. Subscriber ID 602 shows a unique system identifier of a user, device owner, or a corporate IT manager who is responsible for configuring, registering and adjusting policies registered through the system or mobile application. Each reportable state and action are logged into the summary with a time and date stamp 603. The subject location 604 at the time of the reportable state or action is logged into the summary using reportable GPS coordinates. The type of action 605, as related to a registered subject device, such as safe, loss, theft, wipe, recovery, and removed, is logged into the summary at the time the application determines an action causing an event or a system scan determines the subject device type and state 606, such as lost, stolen, self-destruct, restored, deleted and scanning, are unchanged. An authorized user, device owner, or a corporate IT manager looks at a report 607 for any registered subject device in order to determine any patterns of action, commonalities, trends or other such useful data that could reduce the number of triggering events. The report 607 for any subset of a plurality of registered subject devices or the captured universe of all registered subject devices by make, model, location, time and any or all subsets reportable data are of value to, among others, the mobile device and security industries to determine any patterns of action, commonalities, trends or other such useful data of and how device design and functionality, as well as security policies could be changed to address uncovered issues.

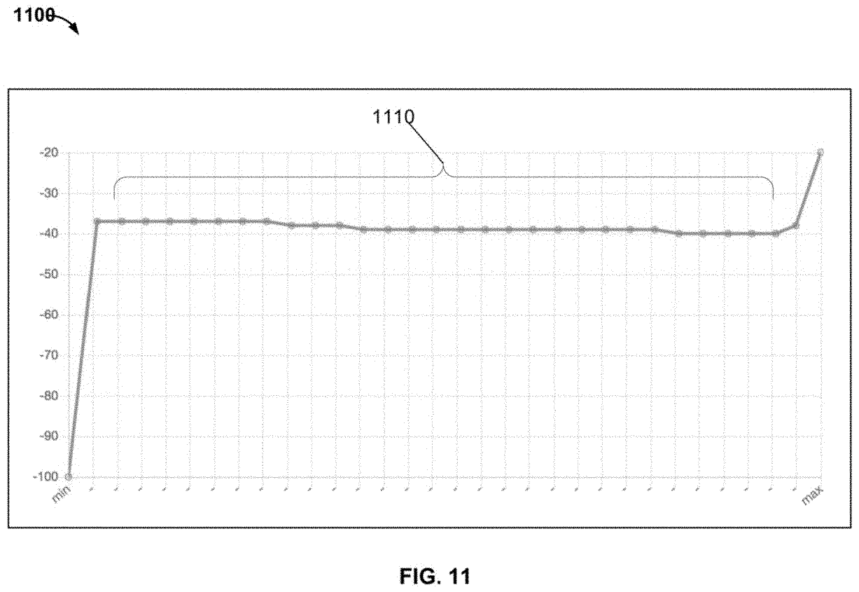

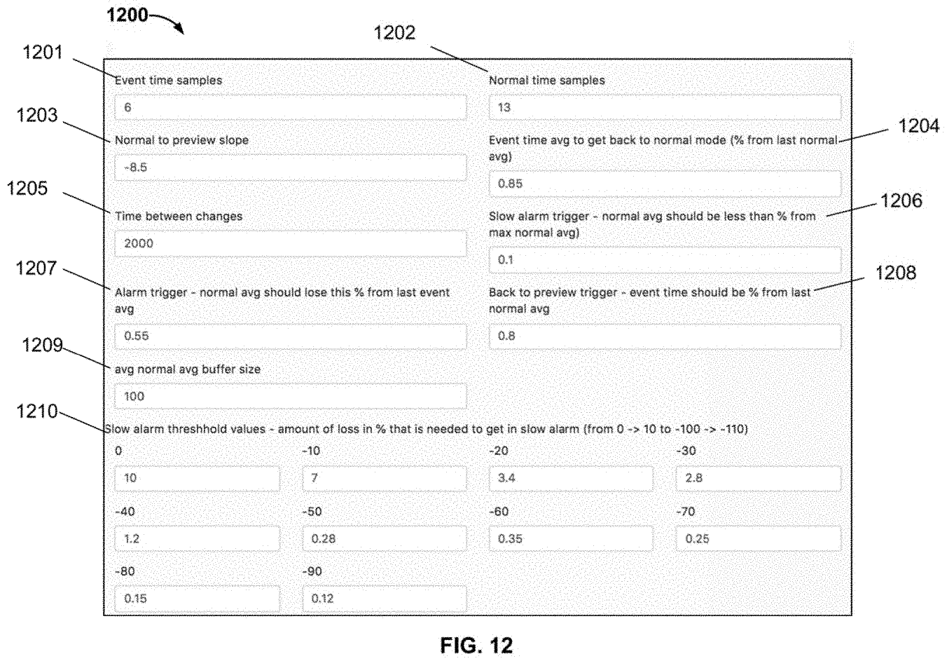

FIG. 11 shows an example of a display 1100 showing a plot or graph of the monitored communications between two devices (e.g., node-to-device communications or fixed-location node communications). In this case, the communications shown on display 1100 are results of an RSSI measurement 1110 obtained from monitoring a wireless communication device over time using a sampling rate. For example, a sampling rate is selected by specifying an interval between samples, which in this case is 50 milliseconds (not shown). Each sample is shown by a point, dot, or small shaded circle on the plot or graph, wherein adjacent samples are joined by a line. In some embodiments, various parameters that determine how the communications are monitored are defined in a user interface as will be described in more detail with respect to FIG. 12.

Returning to the example shown in FIG. 11, a set of representative samples is shown at 1110. In this case, the system determines an expected or normal behavior (e.g., a baseline behavior) for the set of representative samples shown at 1110. The baseline behavior in some cases may be determined by taking an average or other useful aggregate of the set of representative samples at 1110, which in this case, is a value of about −39 RSSI. In other cases, a model is used to capture the baseline behavior (e.g., time series or other model) based at least in part on the set of representative samples at 1110.

FIG. 12 shows an example of a user interface for setting various parameters that determine how the communications (e.g., mobile node-to-device communications or fixed-location node communications, including communications that comprise a measure of proximity or distance) are obtained and monitored by a security node or process. For instance, in the example shown, a set of samples used to determine a change in baseline behavior to detect that an event has happened is selected at 1201 in a field labeled “Event time samples.” In this case, the system is user-configured to select six of the most recently obtained samples (event time samples) and to determine whether an event (e.g., a change to the baseline behavior) has occurred based at least in part on the event time samples. The event is determined based on performing an operation on the event time samples such as, for example, taking an average. If the average of the event time samples exceeds a threshold, the system determines that an event has occurred. The threshold is set depending on the type of event desired to be detected. In the shown example, the end user or an administrator has set the event time samples value to ‘6.’ Decreasing the number of event time samples may increase sensitivity and the rate of false alarms.

A second field 1202 indicates normal time samples for defining baseline behavior of the subject device. In the illustrated example, the user has set the number of samples to 13. The normal to preview slope parameter 1203 defines a rate of change threshold for triggering an alarm, in this example set to −8.5. The event time average to get back to normal mode parameter 1204 defines an amount of time as percentage of the last normal average to deactivate an alert state, here set to 85%. A time between changes parameter 1205 sets a delay of lag between detecting separate events, here set to 2000 milliseconds. A slow alarm trigger parameter 1206 sets a percentage of the maximum average normal time to trigger a slow alarm, here set at 10%. The alarm trigger parameter 1207 sets a percentage of decrease in the normal average time to detect the next event. The back to preview parameter 1208 is similar to 1206, setting a percentage of time but using the most recent (last) normal running average time instead of the maximum normal average, here set at 80%. The buffer size parameter 1209 indicates the number of samples used to compute a normal running average, here set at 100 samples. The slow alarm threshold parameters 1210 are weighting factors used based on the value of the applicable measurement (e.g., RSSI) to compensate for value-dependent varying sensitivity to movement of RSSI. The foregoing parameters may be set by the user locally, by an administrator of multiple subject devices and pushed to each local device, and determined by empirical experimentation or by machine learning using behavior data from a user device or any cohort of user devices. FIG. 10 merely provides a non-limiting example of an interface for setting parameters of a rules-based algorithm for triggering alarms in a subject device. Other parameters, algorithms, or methods for triggering an alarm may also be suitable. For example, a machine-learning algorithm may be useful for determining when to trigger an alarm. Behavior of the nodes can also be used for decisions, e.g., corresponding movement, nodes are spreading apart, or one is leaving; “indicative of wireless connectivity” as used herein can include behavior assessment of subject devices relative to the one or more connected nodes.

Note that, as shown in FIG. 12, the system is configured to receive parameters that define the triggering of both a fast alarm (e.g., an alarm resulting from the detection of an event based on an abrupt change detected over a short period of time) and a slow alarm (e.g., an alarm resulting from the detection of an event based on a gradual change detected over a longer period of time).

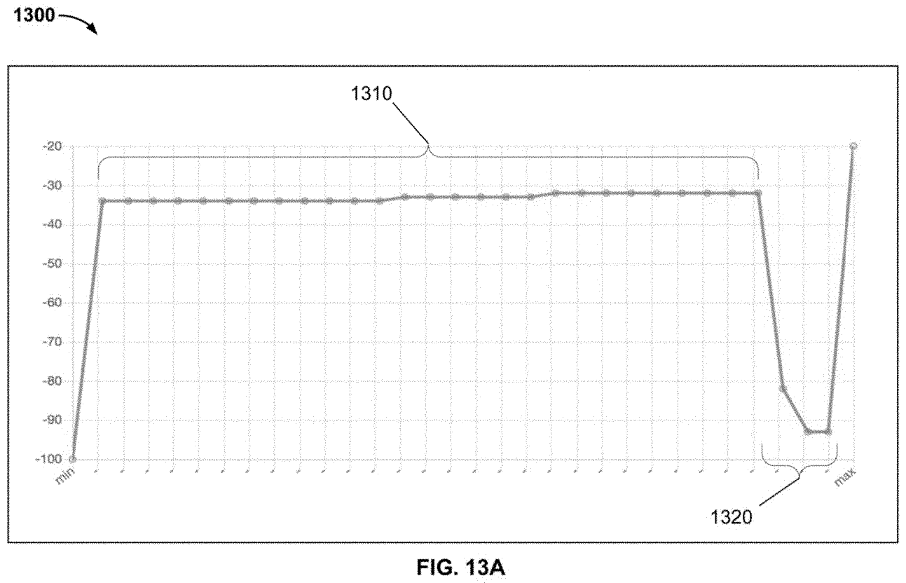

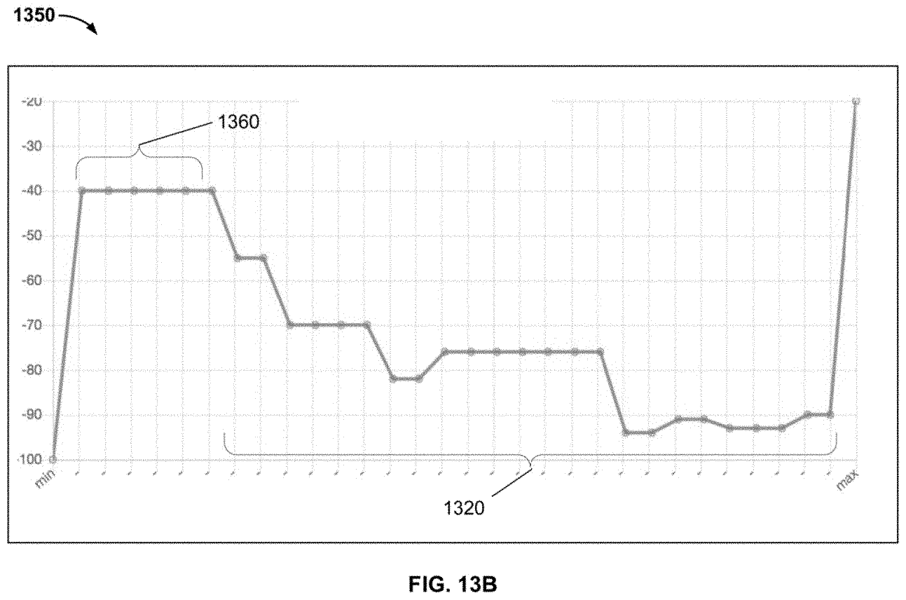

For example, referring to FIG. 13A showing an example of a display 1300 of a plot or graph of the monitored communications between two devices, an event may be used by the subject device to trigger a fast alarm. As in the example of FIG. 11, the system obtains a baseline behavior in response to or based at least in part on sampling the monitored communications to generate a set of samples in time. Each sample is shown by a point, dot, or small shaded circle on the plot or graph, wherein adjacent samples are joined by a line. Here, the system obtains a baseline behavior based at least in part on a set of representative samples shown at 1310. The baseline behavior in some cases is determined by taking an average of the set of representative samples at 1310, which in this case, is a value of about −32 RSSI. In other cases, a model is used to capture the baseline behavior (e.g., time series or other model) based at least in part on the set of representative samples at 1310.

As the system monitors and displays the communications in real time, the communications are shown on display 1300. In this case, display 1300 shows an abrupt change in the RSSI values for samples at 13120, wherein the RSSI value changes from an average of about −32 RSSI to about −92 RSSI over a set of about three samples. This abrupt change in value triggers of both a fast alarm resulting from the detection of an event based on an abrupt change detected over a relatively short period of time or number of samples. The system is configured to receive a set of parameters including a length of time or number of samples defining a window of time used to detect an abrupt change that triggers a fast alarm. In this case, given a sampling interval of 50 milliseconds, a fast alarm period threshold of 5 samples or 250 milliseconds defines a short window, wherein a certain change in RSSI value within the short window triggers a fast alarm. In some cases, a fast alarm value threshold is defined as a percentage of a baseline value (e.g., an average of the set of representative samples used to determine the baseline behavior), and a change is determined to trigger a fast alarm if the difference between a new value of the samples (e.g., an average value of the samples over the short window) and the baseline value exceeds the threshold. In other cases, fast alarm value threshold is set at a specific value wherein an alarm triggering event is detected when the value of samples of the monitored communications exceed the fast alarm value threshold within the short time window. In the example shown, a fast alarm value threshold of −80 RSSI would trigger an alarm resulting from the change in RSSI values shown at 1120.

FIG. 13B shows an example of a display 1350 showing a plot or graph of the monitored communications between two devices, including an event that triggers a slow alarm. As in the examples of FIGS. 11 and 13A, the system obtains a baseline behavior in response to or based at least in part on sampling the monitored communications to generate a set of samples in time. Here, the system obtains a baseline behavior based at least in part on a set of representative samples shown at 1360. As described with respect to the communications monitored and displayed on FIG. 13B, the baseline behavior in some cases is determined by taking an average of the set of representative samples at 1360, which in this case, is a value of about −40 RSSI. In other cases, a model is used to capture the baseline behavior (e.g., time series or other model) based at least in part on the set of representative samples at 1360.

As the system monitors and displays the communications in real time, the communications are shown on display 1350. In this case, display 1350 shows a gradual change in the RSSI values for samples at 1370, wherein the RSSI value changes from about −40 RSSI to about −92 RSSI over a set of about 24 samples. This gradual change in value triggers a slow alarm resulting from the detection of an event based on a gradual change detected over a relatively extended period or number of samples. For example, the system may be configured to receive a set of parameters including a length of time or number of samples defining a window of time used to detect a gradual change that triggers a slow alarm. In this case, given a sampling interval of 50 milliseconds, a slow alarm period threshold of 20 samples or 1000 milliseconds defines an extended window, wherein a certain change in RSSI value within the extended window triggers a slow alarm. In some cases, a slow alarm value threshold is defined as a percentage of a baseline value (e.g., an average of the set of representative samples used to determine the baseline behavior), and a change is determined to trigger a slow alarm if the difference between a new value of the samples (e.g., an average value or median value of samples over the extended window) and the baseline value exceeds the threshold. In other cases, a slow alarm value threshold is set by determining a slope of a fitted line through the samples over the extended window, wherein a slow alarm triggering event is detected when the slope exceeds a threshold value. Additionally, in some cases, the system may be configured to display an indicator that indicates a preview-to-alarm condition or an alarm condition.

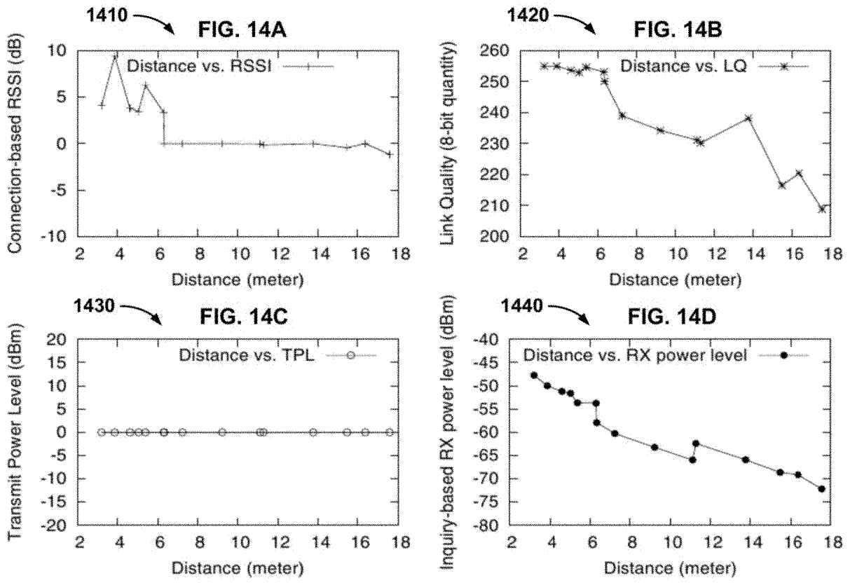

For further example, and in connection with monitoring of node proximities to subject devices using wireless signal indictors to measure proximity, FIGS. 14A-14D show examples of relationships between various indicators plotted on the vertical axes and proximity shown on the horizontal axes as “distance.” FIG. 14A shows a plot 1410 of distance vs. RSSI. FIG. 14B shows a plot 1420 of distance vs. Link Quality (LQ). FIG. 14C shows a plot 1430 of Transmit Power Level (TPL) vs. distance, showing TPL is unresponsive to distance. FIG. 14D shows a plot 1440 of inquiry-based reception power vs. distance, showing a simple linear response. A subject device may use the relationships as indicated to inform parameterization of rules based algorithms for alert determination as described herein. If using a machine learning algorithm, differences in responsiveness profiles may be implicitly handled by training a deep neural network or other machine learning algorithm over a set of training data.

The premise of protection by connection upon which the system and platform are based has several different applications and advantages as it bridges the user's physical and technological worlds to create unique identities, as well as access to apps, programs, websites, devices and networks. Described below are just a few examples of possible applications for the subject device.

### I. Mobile Device and Data Loss/Theft Prevention

In some embodiments, the technique disclosed herein uses as a base for identification, tracking and monitoring, a collection of monitored devices including smart and other wireless devices, mobile devices, or identifiable elements such as wearable devices that can communicate with each other. The technique identifies a user or owner of a monitored device and establish a unique user identifier, signature, or fingerprint using the user's collection of monitored devices, in particular, by monitoring communications between two or more of these devices (including for example, communications that comprise a measure of distance or proximity between two or more of these devices). The technique is then used to keep track of a user's monitored devices relative location, communications to the user and to the user's other monitored devices (including communications that comprise a measure of proximity or distance) to provide better security, content protection and loss prevention for each or any monitored device in the user's collection of monitored devices.

In some cases, the disclosed technique measures or monitors communications between the monitored subject devices and one or more identifiable nodes and uses the communications to determine a proximity or distance. The communications comprise wireless communication signals including but not limited to RSSI, which is a wireless communication proximity unit of measurement, transmission power, receiving power, and other units of measurement or signals for wireless communication. Additionally, in some instances the communications are measured or monitored in real time (e.g., near-instantaneously or almost immediately) as the communications happen. In some cases, the sampling interval between samples of the communications is 50 milliseconds, but can be lower or higher depending on the application.

The disclosed technique includes obtaining a behavior of the monitored devices based at least in part on the communications being measured or monitored in real time. For example, a user who is a frequent traveler might often be in situations requiring a security check (e.g., in an airport) where the user is separated for a period from his or her devices. In these cases, the user's monitored devices may pass through a security check while the user is still waiting to pass through. The disclosed technique automatically monitors communications between each of the monitored devices and the user device and the communications are used to determine a pattern or behavior between each monitored device and the user device as the user goes through security.

In some cases, the technique includes determining a preview-to-alarm condition or an alarm-condition based at least in part on the behavior of the monitored subject devices relative to one or more identifiable nodes. The technique may include determining a preview-to-alarm condition or an alarm-condition based at least in part on the behavior of the monitored devices. In some examples, the behavior of the monitored device may be used to define a baseline behavior metric. The baseline behavior metric may be obtained by monitoring communications between the monitored device and the user device for a set of representative samples (e.g., a set of most recent samples or a set of samples taken over a given period) and determining an expected or normal behavior for the set of representative samples. The baseline behavior metric may in some cases be determined by taking an average of the set of representative samples of the communications. In other cases, a model is used to capture the baseline behavior (e.g., time series or other model) based at least in part on the set of representative samples of the communications.

In some embodiments, determining the preview-to-alarm condition or the alarm condition is based at least in part on detecting a change in the baseline behavior. For example, a baseline behavior is obtained from analyzing a set of representative samples (e.g., an average or time series model of the most recent 100 samples collected from monitoring the communications.) In this case, the baseline behavior represents an expected or normal behavior as captured by the representative samples of the communications between two the monitored device and the user device. The technique monitors the communications, detects a change from the baseline behavior, and in response to or based at least in part on the detected change, determines whether the change triggers a preview-to-alarm condition or an alarm condition. In some cases, the determination of whether the change triggers a preview-to-alarm condition or an alarm condition is based at least in part on whether the change crosses or exceeds a threshold, wherein the threshold to trigger a preview-to-alarm condition is different from the threshold to trigger an alarm condition.

In some cases, the disclosed method may include displaying the real-time node-to-device communications in real time and displaying an indicator that indicates the preview-to-alarm condition or the alarm condition. In some examples, a server may track self-monitoring by a plurality of subject device based on monitoring the node-to-device communications.

### II. Unique Identity and Password Creation and Management

The subject device facilitates the establishment or creation of a confidential identifier or user ID using a proxy for the user that is based on the user's devices rather than a stored or memorized static password. This means that as a dynamic password to manage user access, the passwords are not stored on devices, in password chains or written in a user-created password list. This type of password as established by a collection of user devices and the relationship based on their connectivity and proximities or distances cannot be compromised, stolen or used by someone else.

### III. Unique Dynamic Access Management

Based on the connection of several devices and the determination of location, the user manages any device's access to programs, apps and websites based on location. For example, the user may define that the user can only login to the user's financial institution account when the user is at home and using the user's laptop. Additionally, the user may define that the user can only access company programs when traveling and using a registered iPad device. The user also defines, establishes, and manages which Wi-Fi networks are safe for a device to access.

### IV. Content/Data Protection

In some embodiments, the subject device uses a unique guided process to allow the user, company manager, corporate IT manager, or other authorized person or persons to set standard and customized device and data security policies. This enables companies to fully comply with audit requirements by ensuring that all prescribed device and data security parameters, such as having a unique and complex password in place, enacting secure data back-ups, and other safe measures—are in place and always activated.

### V. Credit Card Use Authorization and Protection

By communicating with new generation credit card smart chips, the subject device provides new credit cards to be activated only by the owner of the registered devices in a defined characteristic location such as the user's home, office, vehicle or a designated safe zone associated with the user. The subject device also manages use of the credit card, for instance by allowing the card to be used only in proximity or a defined distance of the device owner and in certain locations. In this case, the credit card is treated by the system as a node to be selected, registered, tracked and monitored. Other nodes communicate in an ongoing fashion with the credit card, such that the credit card becomes part of wireless communications established or managed by the system.

### VI. Equipment Inventory Location Management, Tracking and Loss Prevention

By using wireless equipment tags to identify equipment and based on user or company-defined policies, critical or high-value equipment are tracked and users alerted to possible loss or theft scenarios. In this case, each piece of equipment is tagged and treated by the system as a node to be selected, registered, tracked and monitored. Other nodes communicate in an ongoing fashion with the tagged equipment, such that the tagged equipment becomes part of wireless communications established or managed by the system. Unlike other inventory systems that are often dependent on a user to log out parts being used or log in new parts, the subject device creates a real-time inventory through continual communication between wireless equipment tags, other registered devices and the subject device.

### VII. Commercial Fleet Vehicle Theft Prevention

Based on the connection of devices and monitoring the proximities or distances between devices placed or fixed in a vehicle that may be part of a commercial fleet, each vehicle having a selected or registered device are tracked and monitored by the system. Accordingly, the vehicle having the device is either automatically locked in park should the driver move away from the vehicle or the engine could be shut off in the event of a possible theft if the system detects or identifies the vehicle (as identified for example by its selected or registered device or devices) moving away from the driver. The defined policy or security measures implement or set a schedule to enable registered users to start the car only during specific hours. These features and functionalities operate automatically without human action or input once the system, platform or application is up and running.

### VIII. Child Monitoring and Protection

Through the use of wireless tags connected with a child, for example, embedded in a child's clothing, the subject device may track the child's location through a registered node or second subject device attached to the child and alert a parent or guardian through the parent's wireless device if the child should move outside of an established security radius. In this case, the child is in effect tagged may be treated by a remote monitoring device as another subject device to be selected, registered, tracked and monitored with reporting to a parent or guardian using a remote terminal. Other nodes communicate in an ongoing fashion with the tagged child, such that the tagged child becomes part of communications established or managed by the system. Again, based on location, there could be a case of a parent walking too far away from the child, the child wandering outside of the security radius, or someone taking the child away. In each case, an appropriate one or set of policies or security measures will be enacted to alert not just the parent but also to automatically alert an appropriate authority. In addition, if a parent walks away from a vehicle with a child left in the vehicle, an alarm is set to alert the parent in response to the system detecting that the user has moved away beyond a predetermined threshold (e.g., a threshold based at least in part on the communications between devices, including communications that comprise a measure or proximity or distance) from the device on the child (e.g. the wireless tag) and has therefore forgotten the child in the vehicle.

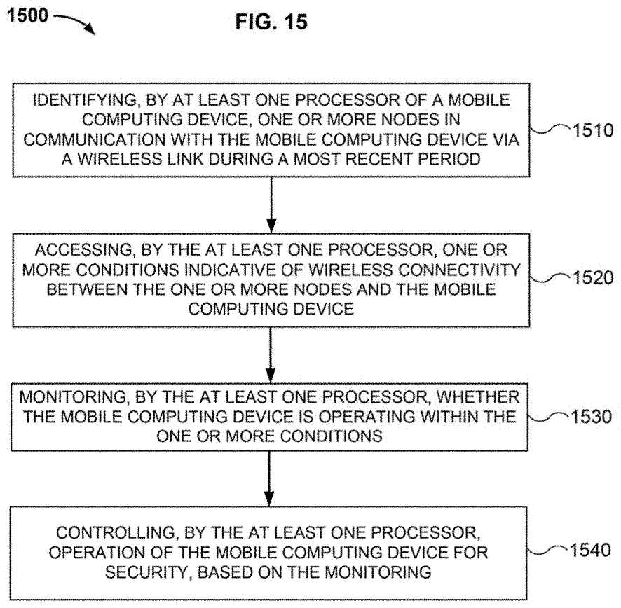

In summary of the foregoing, and by way of further example, FIG. 15 shows operations of a method 1500 method for controlling a mobile computing device (e.g., a “subject device”). Unless otherwise specified or implied, all operations of the methods described herein are performed by the subject device, alone or in cooperation with one or more servers and/or wireless nodes (collectively, the “system”). The subject device should be capable of autonomous operation in performance of the methods but may make use of remote computing resources for certain computational or administrative operations, and generally determines its own security status by communicating or attempting to communicate with various nodes and servers (e.g., GPS transmitters or identifiable nodes).

The method 1500 may include at 1510 identifying, by at least one processor of a mobile computing device, one or more nodes in communication with the mobile computing device via a wireless link during a most recent period. Numerous examples of identifying various nodes may been provided in the disclosure herein above. The identifying may enable the mobile computing device to assess its security status relative to one or more connected nodes of a list or other data structure of recognized nodes as described in the numerous examples herein above. The identifying may, but need not, include obtaining authorized or secure access to any secure node beyond that requires to obtain the minimum useful wireless response, which may be as simple as an access refusal message for which an RSSI or similar measure may be computed. The connected nodes one identified should have some known relationship to the subject device, but it need not be one of ownership or authorized user, useful as those relationships are. For example, if the subject device is frequently used in a public place within range of, but without access to, several wireless access points (WAPs), the method may use an RSSI for the WAPs to determine location and relative movement within a defined security envelope for that location.

The method 1500 may further include at 1520 accessing, by the at least one processor, one or more conditions indicative of wireless connectivity between the one or more nodes and the mobile computing device. As noted above, conditions may be defined by a rules-based algorithm configured by one or more parameters operating on an indicator or proximity or movement (e.g., RSSI, received power, line quality, etc.) or geographic location. The subject device may access configuration parameters and algorithms in its device memory for use in a downstream or parallel monitoring operation 1530. It may have different conditions defined in its memories for different locations, behaviors, or alarms. A set of express or implied conditions (e.g., implied by results of an AI algorithm) for a particular location, use case, or alarm status may be referred to herein as a security envelope pertinent to a zone or other object.

The method 1500 may further include monitoring at 1530, by the at least one processor, whether the mobile computing device is operating within the one or more conditions, for example, by executing a rules-based algorithm or machine learning algorithm. The method 1500 may further include controlling at 1540, by the at least one processor, operation of the mobile computing device for security, based on the monitoring. For example, the subject device may implement a security policy for a determined state (e.g., “safe,” “lost,” “lost-but-safe,” “stolen,” etc.) as described herein above, based which state is indicated by one or more security envelopes.

In an aspect of the method, the wireless link for identifying the one or more nodes may be, or may include, a short-range link selected from the group consisting of a Bluetooth link, a WiFi link, a WiGig link, an RFID link, an infrared link, or an ultrasonic link. In some embodiments, the one or more nodes may include a short-range device having an effective radiated power not greater than 100 mW. In related aspect, the wireless link for identifying the one or more nodes may be or include a cellular data system link, for example a 5G, 4G, or LTE link. In an alternative, or in addition, the node may use a LORA WAN link or any other useful wireless communication link.

The one or more nodes may be, or may include, one or more peers to the mobile computing device each running a complementary one or more conditions indicative of wireless connectivity. The method may include responding to a query from the one or more peers. In addition, the one or more nodes may include one or more non-peers of the mobile computing device, such as a simple client.

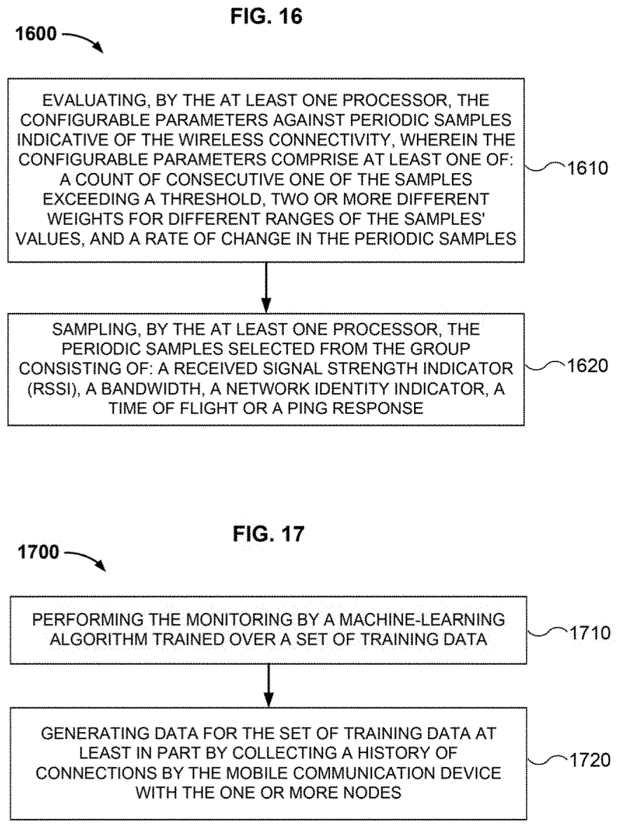

FIGS. 16-19 illustrate additional aspects or operations 1600, 1700, 1800 and 1900 of the method 1500, that may be used in various embodiments. One or more of the operations 1600, 1700, 1800 and 1900 may be omitted in various instantiations of the method 1500, thus, all the operations 1600, 1700, 1800 and 1900 may sometimes be optional. In addition, the method 1500 may include other operations or aspect that are not included in any of the operations 1600, 1700, 1800 or 1900 but that are described elsewhere herein as operations for a subject device or system.

As noted, the at least one processor may perform the monitoring by a rules-based algorithm with configurable parameters. For example, referring to FIG. 16 the method 1500 may further include, at 1610, evaluating, by the at least one processor, the configurable parameters against periodic samples indicative of the wireless connectivity, wherein the configurable parameters comprise at least one of: a count of consecutive one of the samples exceeding a threshold, two or more different weights for different ranges of the samples' values, and a rate of change in the periodic samples. Examples of periodic samples are provided in FIGS. 11, 13A-B, and 14A, 14B, 14D. The subject device may buffer these samples for one or more connected nodes in a memory, up to a cache limit. The parameters may be user configurable, machine configurable, or both.

The method 1500 may further include at 1620 sampling, by the at least one processor, the periodic samples selected from the group consisting of: a received signal strength indicator (RSSI), a bandwidth, a network identity indicator, a time-of-flight or a ping response. Samples may also include a GPS or other triangulated location coordinate, which the subject device may correlate to a safe zone or a location outside of a safe zone.

Referring to FIG. 17, in an alternative aspect of the method 1500, at 1710 the at least one processor may perform the monitoring by a machine-learning algorithm trained over a set of training data. For example, the method 1500 may include at 1720 generating data for the set of training data at least in part by collecting a history of connections by the mobile communication device with the one or more nodes.

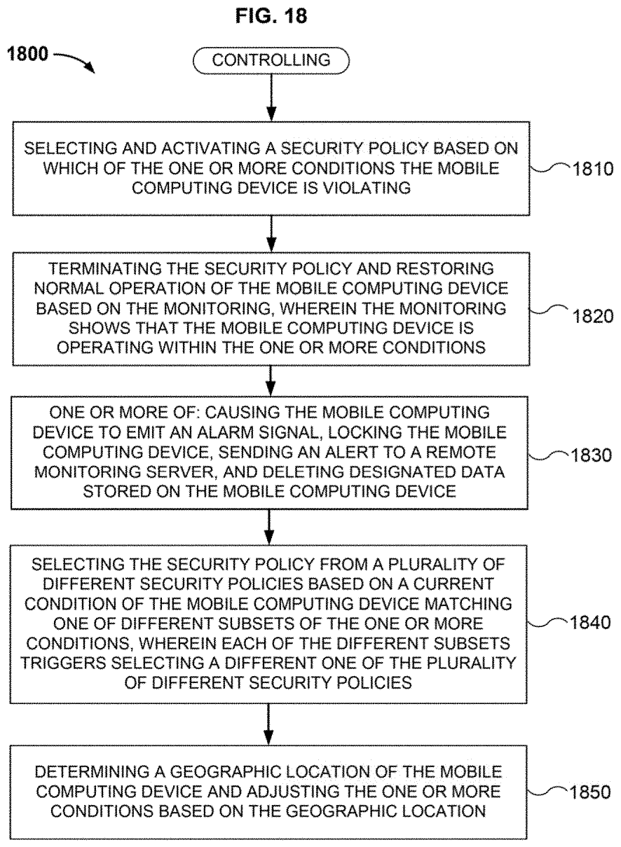

Referring to FIG. 18, the controlling 1540 may include at 1810 selecting and activating a security policy based on which of the one or more conditions the mobile computing device is violating. In a complementary aspect, the method 1500 may include at 1820, by the at least one processor, terminating the security policy and restoring normal operation of the mobile computing device based on the monitoring, when the monitoring shows that the mobile computing device is operating within the one or more conditions. As indicated at 1830, the security policy may include one or more of: causing the mobile computing device to emit an alarm signal, locking the mobile computing device, sending a lost or stolen alert to a remote monitoring server, and deleting designated data stored on the mobile computing device. Alarms may be of various levels, for example, “lost,” “stolen,” “lost but safe,” “stolen,” or “forgotten at home.” The method 1500 may further include at 1840, by the at least one processor, selecting the security policy from a plurality of different security policies based on a current condition of the mobile computing device matching one of different subsets of the one or more conditions, wherein each of the different subsets triggers selecting a different one of the plurality of different security policies. In addition, the method 1500 may include at 1850 determining by the at least one processor a geographic location of the mobile computing device and adjusting the one or more conditions based on the geographic location.

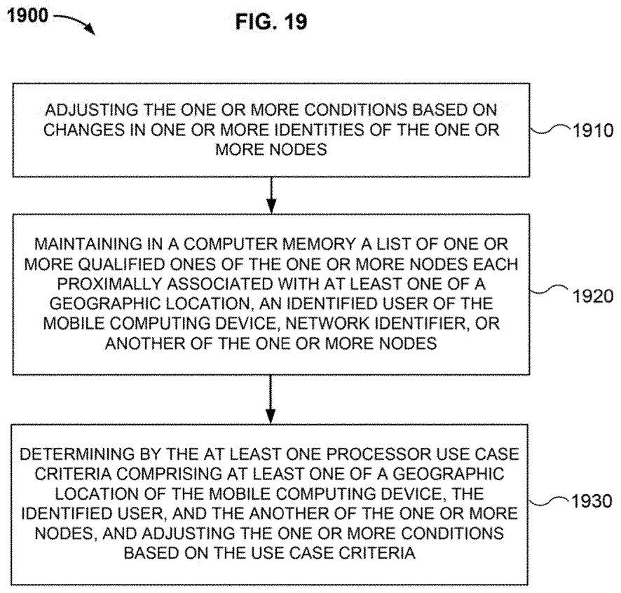

Referring to FIG. 19, the method 1500 may further include at 1910, by the at least one processor, adjusting the one or more conditions based on changes in one or more identities of the one or more nodes. For example, a user may add or drop nodes, or an algorithmic neighborhood node identifier module may automatically add or drop nodes used for zone identification or status determination. In a related aspect, the method may include at 1920, by the at least one processor, maintaining in a computer memory a list of one or more qualified ones of the one or more nodes each proximally associated with at least one of a geographic location, an identified user of the mobile computing device, or another of the one or more nodes. The method 1500 may further include determining at 1930, by the at least one processor, use case criteria comprising at least one of a geographic location of the mobile computing device, the identified user, and the another of the one or more nodes, and adjusting the one or more conditions based on the use case criteria. Performance of the foregoing operations may be in accordance with more detailed examples provided herein above.

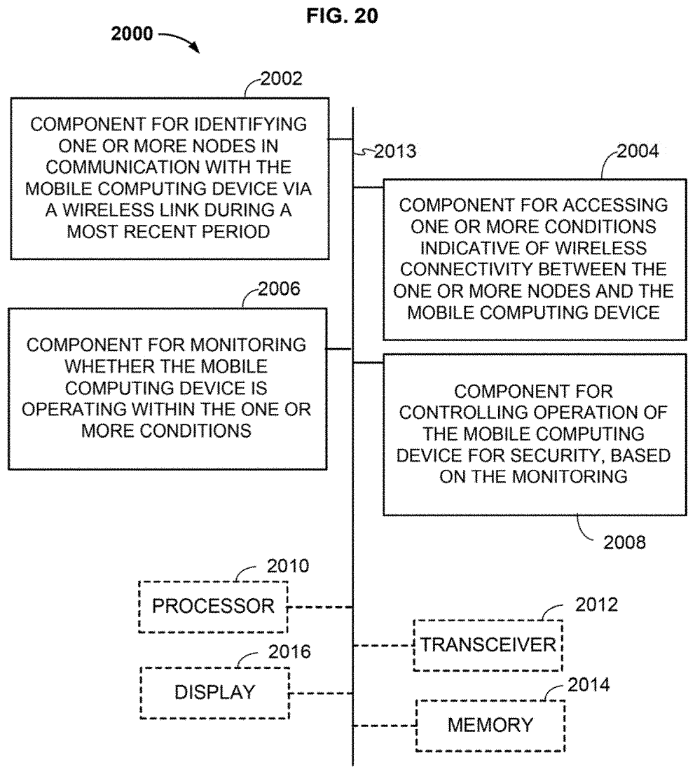

In accordance with the foregoing Figures and accompanying disclosure, and for further example, FIG. 20 illustrates components of a portable computing apparatus 2000 for preventing or minimizing loss or theft thereof, which may operate as part of any system as described herein above. The apparatus or system 2000 may include additional or more detailed components for performing functions or process operations as described herein. For example, the processor 2010 and memory 2014 may contain an instantiation of any operable combination of the processes 100, 160, or 1500-1900. As depicted, the apparatus or system 2000 may include functional blocks that can represent functions implemented by a processor, software, or combination thereof (e.g., firmware). The apparatus 2000 may be a computer functioning as client device, e.g., a smartphone, smartwatch or notepad computer.

As illustrated in FIG. 8, the apparatus or system 2000 may comprise an electrical component 2002 for identifying one or more nodes in communication with the apparatus via a wireless link of the transceiver during a most recent period. The component 2002 may be, or may include, a means for said identifying. Said means may include the processor 2010 coupled to the memory 2014, the processor executing an algorithm based on program instructions stored in the memory. Such algorithm may include a sequence of more detailed operations, for example, the operations 120 shown in FIG. 1B, or equivalent operations.

The apparatus 2000 may further include an electrical component 2004 for accessing one or more conditions indicative of wireless connectivity between the one or more nodes and the apparatus. The component 2004 may be, or may include, a means for said accessing. Said means may include the processor 2010 coupled to the memory 2014 and to the display 2016, the processor executing an algorithm based on program instructions stored in the memory. Such algorithm may include a sequence of more detailed operations, for example, as described in connection with FIG. 4D, 4E, or 10, for example by accessing a data structure in memory and retrieving a set of parameters or an AI module relevant to evaluation of one or more indicators of wireless connectivity.

The apparatus 2000 may further include an electrical component 2006 for monitoring whether the apparatus is operating within the one or more conditions. The component 2006 may be, or may include, a means for said monitoring. Said means may include the processor 2010 coupled to the memory 2014 and to the display 2016, the processor executing an algorithm based on program instructions stored in the memory. Such algorithm may include a sequence of more detailed operations, for example, as described in connection with FIG. 11, 13A, 13B, 16 or 17, or any of the other monitoring examples described herein above.

The apparatus 2000 may further include an electrical component 2008 for controlling operation of the apparatus for security, based on the monitoring. The component 2008 may be, or may include, a means for said controlling. Said means may include the processor 2010 coupled to the memory 2014 and to the display 2016, the processor executing an algorithm based on program instructions stored in the memory. Such algorithm may include a sequence of more detailed operations, for example, as described in connection with FIG. 18, or any of the other control examples (e.g., implementing a security policy) as described herein above.

The apparatus 2000 may optionally include a processor module 2010 having at least one processor. The processor 2010 may be in operative communication with the modules 2002-2008 via a bus 2013 or similar communication coupling. The processor 2010 may schedule and initiate the processes or functions performed by electrical components 2002-2008.

In related aspects, the apparatus 2000 may include a user interface device (not shown) operable for responding to user input and providing an electrical signal indicating the input to the processor 2010. A user interface device may include, for example, a touchscreen (e.g., integrated into display 2016), a touchpad, a computer mouse, or a keyboard. In further related aspects, the apparatus 2000 may optionally include a module for storing information, such as, for example, a memory device 2014. The computer readable medium or the memory module 2014 may be operatively coupled to the other components of the apparatus 2000 via the bus 2013 or the like. The memory module 2014 may be adapted to store computer readable instructions and data for execution by the processor of the processes and behavior of the modules 2002-2008, and subcomponents thereof. The memory module 2014 may retain instructions for executing functions associated with the modules 2002-2008. While shown as being external to the memory 2014, it is to be understood that the modules 2002-2008 can exist within the memory 2014.

The apparatus 2000 may include a transceiver 2012 configured as a wireless transmitter/receiver, for transmitting and receiving a communication signal to/from another system component (e.g., the connected nodes or a remote server). In alternative embodiments, the processor 2010 may include networked microprocessors from devices operating over a computer network. In addition, the apparatus 2000 may be equipped for communicating with networked computers of various types, for example other servers in a home network, cloud storage or remote network that store copies of digital data processed by the apparatus 2000 and executable code for associated algorithms.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the application and design constraints imposed on the overall system. Skilled artisans may implement the described functionality in varying ways for each application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component or a module may be, but are not limited to being, a process running on a processor, a processor, an object, an executable, a thread of execution, a program, and/or a computer. By way of illustration, both an application running on a server and the server can be a component or a module. One or more components or modules may reside within a process and/or thread of execution and a component or module may be localized on one computer and/or distributed between two or more computers.

Various aspects are presented as systems or apparatus that may include several components, modules, and the like. It is to be understood and appreciated that the various systems or apparatus may include additional components, modules, etc. and/or may not include all the components, modules, etc. discussed in connection with the Figures. A combination of these approaches may also be used. The various illustrative logical blocks, modules, and circuits described in connection with the aspects disclosed herein may be executed by a general purpose processor, a digital signal processor (DSP), an application specific integrated circuit (ASIC), a field programmable gate array (FPGA) or other programmable logic device, discrete gate or transistor logic, with discrete hardware components in an apparatus or system designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Operational aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, digital versatile disk (DVD), Blu-ray™, or any other form of non-transitory storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a client device or server. In the alternative, the processor and the storage medium may reside as discrete components in a client device or server.

Furthermore, encoded instructions for a method may be embodied in an article of manufacture using standard programming and/or engineering techniques to produce computer-readable media holding software, firmware, hardware, or any combination thereof to control a computer to implement the disclosed aspects. Non-transitory computer readable media for such purpose can include but are not limited to magnetic storage devices (e.g., hard disk, floppy disk, magnetic strips, or other format), optical disks (e.g., compact disk (CD), DVD, Blu-ray™ or other format), smart cards, and flash memory devices (e.g., card, stick, or other format). Those skilled in the art will recognize many modifications may be made to this configuration without departing from the scope of the disclosed aspects. Thus, the system methods described herein may be embodied in any computer-readable medium for use by or in connection with an instruction execution system, apparatus, or device, such as a computer-based system, processor-containing system, or other system that fetches the instruction execution system, apparatus or device, and execute the instructions. A computer-readable medium may be any device or apparatus that stores, communicates, propagates, or transports a program for use by or in connection with the instruction execution system, apparatus, or device. For example, non-transitory computer-readable medium may be an electronic, magnetic, optical, electromagnetic, infrared, or semiconductor system, apparatus, device, or other storage medium known in the art or yet to be developed.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. For example, process descriptions or blocks in flowcharts as presented in FIGS. 1A-1F, FIG. 2A and FIGS. 15-19 may be understood to represent modules, segments, or portions of code or logic, which include one or more executable instructions for implementing specific logical functions or steps in the associated process. Alternative implementations are included within the scope of the present disclosure in which functions may be executed out of order from the order shown or described herein, including substantially concurrently or in reverse order, depending on the functionality involved, as would be understood by those reasonable skilled in the art after having become familiar with the teachings of the present disclosure. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers.

While preferable embodiments of the present technology have been shown and described herein, it will be obvious to those skilled in the art that such embodiments are provided by way of example only. Numerous variations, changes, and substitutions will now occur to those skilled in the art without departing from the scope of the appended claims. Various alternatives to the embodiments described herein may be employed in practicing within the scope of the appended claims. The following claims define the scope of the what is claimed, including methods and structures within the scope of these claims and their equivalents.

1. A method for controlling a mobile computing device to prevent or minimize loss or theft, the method comprising:
identifying, by at least one processor of a mobile computing device, one or more nodes in communication with the mobile computing device via a wireless link during a most recent period;
accessing, by the at least one processor, one or more conditions indicative of wireless connectivity between the one or more nodes and the mobile computing device;
monitoring, by the at least one processor, whether the mobile computing device is operating within the one or more conditions; and
controlling, by the at least one processor, operation of the mobile computing device for security, based on the monitoring.

2. The method of claim 1, wherein the one or more nodes comprises a short-range device having an effective radiated power not greater than 100 mW.

3. The method of claim 1, wherein the wireless link for identifying the one or more nodes comprises a cellular data system link.

4. The method of claim 1, wherein the at least one processor performs the monitoring by a rules-based algorithm with configurable parameters and the method further comprises evaluating, by the at least one processor, the configurable parameters against periodic samples indicative of the wireless connectivity, wherein the configurable parameters comprise at least one of: a count of consecutive one of the samples exceeding a threshold, two or more different weights for different ranges of the samples' values, and a rate of change in the periodic samples.

5. The method of claim 4, further comprising sampling, by the at least one processor, the periodic samples selected from the group consisting of: a received signal strength indicator (RSSI), a bandwidth, a network identity indicator, or a ping response.

6. The method of claim 1, wherein the at least one processor performs the monitoring by a machine-learning algorithm trained over a set of training data, and the method further comprises generating data for the set of training data at least in part by collecting a history of connections by the mobile communication device with the one or more nodes.

7. The method of claim 1, wherein the one or more nodes comprises one or more peers to the mobile computing device each running a complementary one or more conditions indicative of wireless connectivity, and further comprising responding to a query from the one or more peers.

8. The method of claim 1, wherein the controlling comprises at least one of (a) selecting and activating a security policy based on which of the one or more conditions the mobile computing device is violating, (b) terminating the security policy and restoring normal operation of the mobile computing device based on the monitoring, wherein the monitoring shows that the mobile computing device is operating within the one or more conditions, (c) selecting the security policy from a plurality of different security policies based on a current condition of the mobile computing device matching one of different subsets of the one or more conditions, wherein each of the different subsets triggers selecting a different one of the plurality of different security policies, and (d) wherein selecting the security policy includes selecting or more of: causing the mobile computing device to emit an alarm signal, locking the mobile computing device, sending a lost or stolen alert to a remote monitoring server, and deleting designated data stored on the mobile computing device.

9. The method of claim 1, further comprising determining by the at least one processor a geographic location of the mobile computing device and adjusting the one or more conditions based on the geographic location.

10. The method of claim 1, further comprising by the at least one processor, adjusting the one or more conditions based on changes in one or more identities of the one or more nodes, alone or in combination with one or more of: maintaining in a computer memory a list of one or more qualified ones of the one or more nodes each proximally associated with at least one of a geographic location, an identified user of the mobile computing device, or another of the one or more nodes, and determining use case criteria comprising at least one of a geographic location of the mobile computing device, the identified user, and the another of the one or more nodes, and adjusting the one or more conditions based on the use case criteria.

11. A portable computing apparatus for preventing or minimizing loss or theft thereof, comprising at least one processor coupled to a wireless transceiver and to a memory, the memory holding program instructions that when executed by the processor cause the apparatus to perform:
identifying one or more nodes in communication with the apparatus via a wireless link of the transceiver during a most recent period;
accessing one or more conditions indicative of wireless connectivity between the one or more nodes and the apparatus;
monitoring whether the apparatus is operating within the one or more conditions; and
controlling operation of the apparatus for security, based on the monitoring.

12. The apparatus of claim 11, wherein the one or more nodes comprises a short-range device having an effective radiated power not greater than 100 mW.

13. The apparatus of claim 11, wherein the wireless link for identifying the one or more nodes comprises a cellular data system link.

14. The apparatus of claim 11, wherein the memory holds further instructions for performing the monitoring by a rules-based algorithm with configurable parameters and for evaluating, by the at least one processor, the configurable parameters against periodic samples indicative of the wireless connectivity, wherein the configurable parameters comprise at least one of: a count of consecutive one of the samples exceeding a threshold, two or more different weights for different ranges of the samples' values, and a rate of change in the periodic samples.

15. The apparatus of claim 14, wherein the memory holds further instructions for sampling the periodic samples selected from the group consisting of: a received signal strength indicator (RS SI), a bandwidth, a network identity indicator, or a ping response.

16. The apparatus of claim 11, wherein the memory holds further instructions for performing the monitoring by a machine-learning algorithm trained over a set of training data, and for generating data for the set of training data at least in part by collecting a history of connections by the mobile communication device with the one or more nodes.

17. The apparatus of claim 11, wherein the one or more nodes comprises one or more peers to the apparatus each running a complementary secure use component, and wherein the memory holds further instructions for responding to a query from the one or more peers.

18. The apparatus of claim 11, wherein the memory holds further instructions for performing the controlling by at least in part one of (a) selecting and activating a security policy based on which of the one or more conditions the mobile computing device is violating, (b) terminating the security policy and restoring normal operation of the mobile computing device based on the monitoring, wherein the monitoring shows that the mobile computing device is operating within the one or more conditions, (c) selecting the security policy from a plurality of different security policies based on a current condition of the mobile computing device matching one of different subsets of the one or more conditions, wherein each of the different subsets triggers selecting a different one of the plurality of different security policies, and (d) wherein selecting the security policy includes selecting or more of: causing the mobile computing device to emit an alarm signal, locking the mobile computing device, sending a lost or stolen alert to a remote monitoring server, and deleting designated data stored on the mobile computing device.

19. The apparatus of claim 11, wherein the memory holds further instructions for determining a geographic location of the mobile computing device and adjusting the one or more conditions based on the geographic location.

20. The apparatus of claim 11, wherein the memory holds further instructions for adjusting the one or more conditions based on changes in one or more identities of the one or more nodes, alone or in combination with one or more of: maintaining in a computer memory a list of one or more qualified ones of the one or more nodes each proximally associated with at least one of a geographic location, an identified user of the mobile computing device, or another of the one or more nodes, and determining use case criteria comprising at least one of a geographic location of the mobile computing device, the identified user, and the another of the one or more nodes, and adjusting the one or more conditions based on the use case criteria.
